(19) United States
(12) Patent Application Publication
(10) Pub. No.: US 2008/0230755 A1
(43) Pub. Date: Sep. 25, 2008

(54) INK FOR COLOR FILTER, COLOR FILTER, IMAGE DISPLAY DEVICE, AND ELECTRONIC APPARATUS

(75) Inventors: Hiroshi TAKIGUCHI, Suwa (JP); Hiroshi KIGUCHI, Suwa (JP); Masaya SHIBATANI, Matsumoto (JP); Mitsuhiro ISOBE, Kofu (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/052,998

(22) Filed: Mar. 21, 2008

(30) Foreign Application Priority Data
Mar. 22, 2007 (JP) 2007-075673

(51) Int. Cl. G02B 5/23; B41J 2/175

(52) U.S. Cl. 252/586; 347/84

(57) ABSTRACT

A color filter ink for manufacturing a color filter with an ink-jet method. The ink includes a colorant and a liquid medium into which the colorant is dissolved and/or dispersed. The liquid medium includes at least one ether oxygen atom within a molecule, in addition to radicals provided at both ends of a molecular chain, the radicals both being selected from an alkoxyl group and an acetyl group. If a hardened butyl rubber is sealed inside the liquid medium for 10 days under atmospheric pressure at 40° C., a swelling ratio of the hardened butyl rubber is not higher than 20%,

### CROSS REFERENCE TO RELATED CASES

This application claims priority to Japanese Patent Application No. 2007-075673 filed Mar. 22, 2007 which is hereby expressly incorporated by reference herein in its entirety.

### BACKGROUND

1. Technical Field

The present invention relates to ink for color filters, a color filter, an image display device, and an electronic apparatus.

2. Related Art

Color filters are commonly used for liquid crystal display devices (LCD) for color displays.

Color filters have been manufactured using a method referred to as photolithography, the method including: forming a coating on a substrate, the coating composed of materials (compositions for forming colored layers) including a colorant, a photosensitive resin, a functional monomer, a polymerization initiator, and the like; thereafter carrying out processing sets such as photosensitive processing of light irradiation through a photomask and development. Generally in such method, color filters are manufactured so that color filters for one color do not overlap with the color filters of another color by repeating the following steps for each color: forming a coating on the entire substrate, curing only part of the coating, and removing the majority of the coating excluding the cured part. In other words, the color filters ultimately obtained include only a part of the coatings formed in the manufacturing of the color filters, and the majority of the coating is removed during the manufacturing process of the color filters. Such a method increases the manufacturing cost of color filters, and causes undesirable resource usage.

On the other hand, in recent years, a method has been suggested for forming colored layers of the color filters using a droplet discharge device provided with an inkjet head (droplet discharge head). For example, refer to JP-A-2002-372613. This method allows easy control of the discharging positions of droplets of materials for forming color layers (compositions for forming colored layers), as well as the reduction of the waste of the compositions for forming colored layers. Consequently, the environmental load and the manufacturing cost are reduced. However, such a manufacturing method of color filters using an inkjet head inherits a problem that discharging droplets for a long period of time causes instability in the discharging quantity. Such a problem causes unevenness in the coloring density of the coloring portions which are essential to having identical coloring density. This results in irregularities such as color irregularity and density irregularity in different parts of the color filters. Moreover, the reliability of color filters is reduced due to the uneven characteristics (specifically color attributes such as contrast ratio and color reproduction area) in multiple color filters. Further, droplet discharge devices (industrial) used for manufacturing the color filters are entirely different from the ones applied to printers (consumer use). For instance, the industrial droplet discharge device is required to be able to discharge a large amount of droplets for a long period of time for mass production. Moreover, the ink (ink for a color filter) used in the industrial droplet discharge device applied to the manufacturing of color filters is based on an organic solvent, and has higher viscosity and a larger specific gravity compared to ink used in consumer use printers. Therefore, the industrial droplet discharge devices receive a greater load compared to consumer use printers. In a common inkjet method, the rapid deterioration of the constituting members (components) of droplet discharge devices caused by these harsh conditions requires those components to be frequently exchanged or repaired during the manufacturing of color filters. After exchanging or repairing the components, it has been necessary to readjust the discharge conditions of droplets (for instance, voltage waveform regulation and the like) in order to suppress the fluctuation in the characteristics of multiple color filters being manufactured, resulting in reduced productivity of the color filters.

### SUMMARY

An advantage of the invention is to provide inkjet ink for color filters which reduces irregularities of colors and densities in different parts of a color filter, the ink being suitably used in a stable manner for the manufacturing of color filters that are provided with an outstanding uniformity of characteristics between individual units. Another advantage is to provide color filters that are provided with an outstanding uniformity of characteristics between individual units, and with reduced irregularities of colors and densities in different parts of the color filter. Still another advantage is to provide an image display device and an electronic apparatus provided with such color filters.

Such advantages are achieved by the following aspects of the invention.

According to a first aspect of the invention, an color filter ink includes a colorant, and a liquid medium into which the colorant is dissolved and/or dispersed. If hardened butyl rubber is sealed inside the liquid medium for 10 days under atmospheric pressure at 40° C., a swelling ratio of the hardened butyl rubber is not higher than 20%. The liquid medium includes at least one ether oxygen atom within a molecule, in addition to radicals provided at both ends of a molecular chain, the radicals both being selected from an alkoxyl group and an acetyl group. The ink is used for manufacturing a color filter with an ink-jet method.

The inkjet ink for color filters is therefore provided. The ink reduces irregularities of colors and densities in different parts of the color filters and is used in a stable manner in the manufacturing of such color filters. Further, the color filters have excellent uniformity of characteristics between individual units.

In the color filter ink according to the first aspect of the invention, it is preferable that the liquid medium include at least two ether oxygen atoms within a molecule, in addition to radicals provided at both ends of a molecular chain, the radicals both being selected from the alkoxyl group and the acetyl group.

This effectively prevents deterioration in the constituting members (components) of droplet discharge devices that discharge the color filter ink, thereby producing high quality color filters provided with excellent uniformity of characteristics between individual units.

In this case, it is preferable that the liquid medium have a straight-chain molecular structure which does not include a side chain.

This effectively prevents deterioration in the constituting members (components) of droplet discharge devices discharging the color filter ink, thereby producing high quality color filters provided with excellent uniformity of characteristics between individual units.

In this case, it is preferable that the color filter ink be used for a droplet discharge device in which a joint material is formed with the butyl rubber, the joint material joining an inkjet head for discharging droplets and a fluid transfer tube for sending the color filter ink.

This effectively prevents deterioration in the constituting members (components) of droplet discharge devices that discharge the color filter ink, thereby producing high quality color filters provided with excellent uniformity of characteristics between individual units.

If hardened fluorosilicone rubber is sealed inside the liquid medium for 10 days under atmospheric pressure at 40° C., it is preferable that a swelling ratio of the hardened fluorosilicone rubber is not higher than 7%.

This effectively prevents clogging in the droplet discharge head and deterioration in the constituting members (components) of droplet discharge devices that discharge the color filter ink, thereby producing high quality color filters provided with excellent uniformity of characteristics between individual units.

In this case, it is preferable that the boiling point of the liquid medium under an atmospheric pressure be between 180 and 300° C. inclusive.

This effectively prevents clogging in the droplet discharge head that discharges the color filter ink, thereby enhancing the productivity of the color filter.

In this case, it is preferable that the vapor pressure of the liquid medium at 25° C. be 0.1 mmHg or lower.

This effectively prevents clogging in the droplet discharge head that discharges the color filter ink, thereby enhancing the productivity of the color filter.

According to a second aspect of the invention, a color filter is manufactured using the color filter ink according to the first aspect of the invention.

This provides color filters which reduce the irregularities of colors and densities in different parts, thereby providing those color filters with excellent uniformity of characteristics between individual units.

According to a third aspect of the invention, an image display device includes the color filter according to the first aspect of the invention.

This provides image display devices which reduce the irregularities of colors and densities in different parts of a display unit, thereby providing those image display devices with excellent uniformity of characteristics between individual units.

In this case, it is preferable that the image display device be a liquid crystal panel.

This provides image display devices which reduce the irregularities of colors and densities in different parts of a display unit, thereby providing those image display devices with excellent uniformity of characteristics between individual units.

According to a fourth aspect of the invention, an electronic apparatus includes the image display device according to the second aspect of the invention.

This provides electronic apparatuses which reduce the irregularities of colors and densities in different parts of a display unit, thereby providing those electronic apparatuses with excellent uniformity of characteristics between individual units.

### BRIEF DESCRIPTION OF THE DRAWINGS

Embodiments of the invention will be described with reference to the accompanying drawings, wherein like numbers reference like elements.

FIG. 1 is a schematic drawing illustrating an embodiment of a color filter according to an aspect of the invention.

FIG. 2 is a sectional drawing illustrating a method for manufacturing the color filter.

FIG. 3 is a perspective view illustrating a droplet discharge device used for manufacturing the color filter.

FIG. 4 is a drawing of a droplet discharge unit of the droplet discharge device shown in FIG. 3 when viewed from a stage thereof.

FIG. 5 is a drawing illustrating a bottom surface of a droplet discharge head of the droplet discharge device shown in FIG. 3.

FIGS. 6A and 6B are drawings illustrating a bottom surface of a droplet discharge head of the droplet discharge device shown in FIG. 3, where FIG. 6A is a sectional perspective view and FIG. 6B is a sectional view.

FIG. 7 is a sectional drawing illustrating an embodiment of a liquid crystal display device.

FIG. 8 is a perspective view illustrating a structure of a mobile (or notebook) personal computer in which an electronic apparatus according to aspects of the invention is applied.

FIG. 9 is a perspective view illustrating a mobile (including personal handyphone system) phone to which an electronic apparatus according to aspects of the invention is applied.

FIG. 10 is a perspective view illustrating the structure of a digital still camera to which an electronic apparatus according to aspects of the invention is applied.

### DESCRIPTION OF EXEMPLARY EMBODIMENTS

Suitable examples of the present invention will now be described.

### Color Filter Ink

The color filter ink according to the aspects of the invention is used in the manufacturing of color filters (forming of the coloring portion of color filters), and particularly in the manufacturing of the color filters with the inkjet method.

The color filter ink includes substances such as a colorant, a liquid medium into which the colorant is dissolved and/or dispersed, and resin material.

### Colorant

The color filters generally have coloring portions of different colors (generally, three colors corresponding to RGB). Colorants are normally selected in accordance with color tones of the coloring portions to be formed. Examples of colorants constituting the color filter ink sets include various pigments and dyes.

Examples of pigments include: C.I. pigment red 2, 3, 5, 17, 22, 23, 38, 81, 48:1, 48:2, 48:3, 48:4, 49:1, 52:1, 53:1, 57:1, 63:1, 112, 122, 144, 146, 149, 66, 170, 176, 177, 178, 179, 185, 202, 207, 209, 254, 101, 102, 105, 106, 108, and 108:1; C.I. pigment green 7, 36, 15, 17, 18, 19, 26, and 50; C.I. pigment blue 1, 15, 15:1, 15:2, 15:3, 15:4, 15:6, 17:1, 18, 60, 27, 28, 29, 35, 36, and 80; C.I. pigment yellow 1, 3, 12, 13, 14, 17, 55, 73, 74, 81, 83, 93, 94, 95, 97, 108, 109, 110, 129, 138, 139, 150, 151, 153, 154, 168, 184, 185, 34, 35, 35:1, 37, 37:1, 42, 43, 53, and 157; C.I. pigment violet 1, 3, 19, 23, 50, 14, and 16; C.I. pigment orange 5, 13, 16, 36, 43, 20, 20:1, and 104; and C.I. pigment brown 25, 7, 11, and 33.

Examples of colorants include dyes such as azos, anthraquinones, polycyclic aromatic carbonyls, indigoids, carboniums, phthalocyanines, methines, and polymethines. Examples of dyes include: C.I. direct red 2, 4, 9, 23, 26, 28, 31, 39, 62, 63, 72, 75, 76, 79, 80, 81, 83, 84, 89, 92, 95, 111, 173, 184, 207, 211, 212, 214, 218, 221, 223, 224, 225, 226, 227, 232, 233, 240, 241, 242, 243, and 247; C.I. acid red 35, 42, 51, 52, 57, 62, 80, 82, 111, 114, 118, 119, 127, 128, 131, 143, 145, 151, 154, 157, 158, 211, 249, 254, 257, 261, 263, 266, 289, 299, 301, 305, 319, 336, 337, 361, 396, and 397; C.I. reactive red 3, 13, 17, 19, 21, 22, 23, 24, 29, 35, 37, 40, 41, 43, 45, 49, and 55; C.I. basic red 12, 13, 14, 15, 18, 22, 23, 24, 25, 27, 29, 35, 36, 38, 39, 45, and 46; C.I. direct violet 7, 9, 47, 48, 51, 66, 90, 93, 94, 95, 98, 100, and 101; C.I. acid violet 5, 9, 11, 34, 43, 47, 48, 51, 75, 90, 103, and 126; C.I. reactive violet 1, 3, 4, 5, 6, 7, 8, 9, 16, 17, 22, 23, 24, 26, 27, 33, and 34; C.I. basic violet 1, 2, 3, 7, 10, 15, 16, 20, 21, 25, 27, 28, 35, 37, 39, 40, and 48; C.I. direct yellow 8, 9, 11, 12, 27, 28, 29, 33, 35, 39, 41, 44, 50, 53, 58, 59, 68, 87, 93, 95, 96, 98, 100, 106, 108, 109, 110, 130, 142, 144, 161, and 163; C.I. acid yellow 17, 19, 23, 25, 39, 40, 42, 44, 49, 50, 61, 64, 76, 79, 110, 127, 135, 143, 151, 159, 169, 174, 190, 195, 196, 197, 199, 218, 219, 222, and 227; C.I. reactive yellow 2, 3, 13, 14, 15, 17, 18, 23, 24, 25, 26, 27, 29, 35, 37, 41, and 42; C.I. basic yellow 1, 2, 4, 11, 13, 14, 15, 19, 21, 23, 24, 25, 28, 29, 32, 36, 39, and 40; C.I. acid green 16; C.I. acid blue 9, 45, 80, 83, 90, and 185; and C.I. basic orange 21, and 33.

Surface processing such as lyophilic treatment may be carried out on the powder composed with the materials described above, in order to improve the affinity with a liquid medium described later, and the resultant thereof may be used as the colorants. This will improve, in particular, the dispersibility and stability of colorant particulates within the color filter ink. An example of surface treatment includes modification of the particle surface of colorants with polymers. Examples of polymers for modifying the particle surface of colorants include the ones described in JP-A-8-259876, as well as various commercially-supplied polymers or oligomers for dispersing pigments.

The constituents of colorants may be used in combinations of two or more selected from the above.

The colorants of the color filter ink may be dissolved or dispersed into the liquid medium described later. If the colorants are dispersed, the preferable range of an average particle size is 20 nm to 200 nm, and in particular, a range of 30 nm to 180 nm is preferable. This makes the chromic property of the color filters and the dispersion stability of colorants within the color filter ink outstanding, while sufficiently providing the color filters manufactured using the color filter ink with light resistance.

The preferable mass content of the colorant within the color filter ink is between 2 and 20 wt % inclusive, and particularly, between 3 and 15 wt %. Setting the mass content of the colorant within the range described above provides the color filters to be manufactured with outstanding durability, while providing excellent discharging performance (discharging stability) of a droplet discharge head (inkjet head) for color filters. Moreover, it ensures sufficient color density in the color filters to be manufactured.

### Liquid Medium

The liquid medium has the ability to dissolve and/or diffuse the above-described colorants. In other words, the liquid medium functions as a solvent and/or the dispersion medium. Here, the majority of the liquid medium is generally removed during the process of manufacturing color filters.

The liquid medium of the color filter ink according to the first aspect of the invention has, in addition to at least one ether oxygen atom per molecule, radicals provided at both ends of the molecular chain, the radicals including either the alkoxyl group or the acetyl group. Moreover, the liquid medium for the color filter ink satisfies the condition that the swelling ratio of butyl rubber allowed to stand for 10 days inside this liquid medium in a sealed state under atmospheric pressure at 40° C. is no more than 20%, where the swelling ratio indicates the weight increase of the butyl rubber (hereafter this condition may be referred to as “the swelling ratio of butyl rubber”). Satisfying the above condition stabilizes other conditions such as a discharge quantity of droplets throughout the long period of discharging during the manufacturing of color filters using the inkjet method. Consequently, the manufacturing of color filters is carried out with stable quality for a long period of time. In other words, the color filters are manufactured with reduced irregularities of colors and densities in different parts, while being provided with excellent uniformity of characteristics between individual units, in a stable manner for a long period of time. Moreover, satisfying the above conditions effectively prevents the deterioration of the constituting members (components) of the droplet discharge device used for droplet discharging. Consequently, in the case of manufacturing a large number of color filters, the frequency of maintenance such as exchanging or repairing the constituting members (components) of the droplet discharge device is reduced, thereby improving the productivity of the color filters.

If the swelling ratio of butyl rubber in the liquid medium is too large, the discharging condition of droplets becomes unstable when discharging droplets for a long period of time in the manufacturing of color filters using the inkjet method. This makes it difficult to sufficiently reduce the irregularities of colors and densities in different parts of the color filters being manufactured. Moreover, when producing a large number of color filters, the characteristics of color filters fluctuate between individual units. This makes it difficult to manufacture high-quality color filters in a stable manner. The swelling ratio of butyl rubber is measured using, for instance, a disk-shaped testing piece with a diameter of 6 mm and a thickness of 4 mm, formed with solid (hardened) butyl rubber.

As described, according to the first aspect of the invention, the swelling ratio of butyl rubber is no more than 20%, wherein the swelling ratio indicates the weight increase of butyl rubber that is allowed to stand for 10 days inside the liquid medium in a sealed state under atmospheric pressure at 40° C. However, the preferable swelling ratio is no more than 15%, and in particular, no more than 10% is highly preferable, thereby making the advantage of the invention more prominent.

Not using the liquid medium having the aforementioned chemical constitution results in difficulties in sufficiently preventing the negative effect on the components (parts) of the droplet discharge device, as well as in setting the viscosity and a vapor pressure (volatility resistance) of the color filter ink to a preferable value. Specifically, examples of such undesirable compounds include: a compound including the alkoxy group at one end of the molecular chain and the acetyl group at the other end of the molecular chain; and a compound which, while including one of alkoxy and acetyl groups, no other ether oxygen atom is contained therein. Consequently, in the manufacturing of color filters using the inkjet method, a long term droplet discharge makes the droplet discharge condition unstable. This makes it difficult to sufficiently reduce the irregularities of color, density and the like in the respective parts of the color filters being manufactured. Moreover, when producing a large number of color filters, the characteristics of color filters fluctuate between individual units. This makes it difficult to manufacture high-quality color filters in a stable manner.

Examples of compounds used as a liquid medium having the chemical constitution described above include: triethylene glycol dimethyl ether, triethylene glycol diacetate, bis(2-butoxyethyl)ether, tetraethylene glycol dimethyl ether, dipropylene glycol dimethyl ether, diethylene glycol dimethyl ether, diethylene glycol ethyl methyl ether, diethylene glycol diethyl ether, and triethylene glycol butyl methyl ether. Compounds selected from the above may be used alone or in combinations of two or more.

The liquid medium of the color filter ink according to the first aspect of the invention has, in addition to having at least one ether oxygen atoms in a molecule, radicals provided at both ends of the molecular chain, the radicals including either alkoxyl group or acetyl group. However, it is preferable that the liquid medium includes at least two ether oxygen atoms in a molecule, in addition to either the alkoxyl group or the acetyl group provided at both ends of the molecule. This effectively prevents deterioration in the constituting members (components) of droplet discharge devices discharging the color filter ink, thereby producing high quality color filters provided with excellent uniformity of characteristics between individual units. Examples of the compound (liquid medium) include triethylene glycol dimethyl ether, triethylene glycol diacetate, tetraethylene glycol dimethyl ether, and triethylene glycol butyl methyl ether, the compound having at least two ether oxygen atoms in a molecule, in addition to radicals provided at both ends of the molecular chain, the radicals including either the alkoxyl group or the acetyl group.

It is preferable that the liquid medium include a straight-chain molecular structure which does not include a side chain. This effectively prevents deterioration in the constituting members (components) of droplet discharge devices discharging the color filter ink, thereby producing high quality color filters provided with excellent uniformity of characteristics between individual units. Examples of compounds (liquid medium) having a straight-chain chemical constitution without a side chain include: triethylene glycol dimethyl ether, triethylene glycol diacetate, bis(2-butoxyethyl)ether, tetraethylene glycol dimethyl ether, dipropylene glycol dimethyl ether, diethylene glycol dimethyl ether, diethylene glycol ethyl methyl ether, diethylene glycol diethyl ether, and triethylene glycol butyl methyl ether.

It is preferable that the liquid medium satisfy the following conditions. The preferable swelling ratio of fluorosilicone rubber is no more than 7%, wherein the swelling ratio indicates the weight increase of fluorosilicone rubber that is allowed to stand for 10 days inside the liquid medium in a sealed state under atmospheric pressure at 40° C. (hereafter this condition may be referred to “the swelling ratio of fluorosilicone rubber”). Particularly, no more than 5% is preferable. Fluorosilicone rubber is a material generally used as a joining material that joins an ink supply unit and a head drive unit within the head of the droplet discharge head (in particular, at a vicinity of a nozzle plate) of the droplet discharge device described later. The swelling of fluorosilicone rubber in the droplet discharge device may result in problems such as: the ink leaking out to an external unit, reducing the supply capability of ink and preventing an appropriate discharge; and a swollen member piece eluting out, clogging the nozzles. Moreover, the rubber component eluting out to color filters causes the deterioration of product properties. Using a liquid medium that has a low swelling ratio of fluorosilicone rubber effectively prevents problems such as deterioration of the constituting members (components) of droplet discharge devices that discharge the color filter ink, and clogging of the droplet discharge heads, thereby producing higher quality color filters provided with excellent uniformity of characteristics between individual units. The swelling ratio of fluorosilicone rubber is measured using, for instance, a disk-shaped testing piece with a diameter of 6 mm and a thickness of 4 mm, formed with solid (hardened) fluorosilicone rubber.

The preferable range for the boiling point of the liquid medium in atmospheric pressure (1 atmosphere) is between 180 and 300° C. inclusive, and in particular, between 190 and 290° C. inclusive. More specifically, a range between 230 and 280° C. is highly preferable. Having the boiling point of the liquid medium in atmospheric pressure within the range described above effectively prevents clogging in the droplet discharge head which discharges the color filter ink, thereby making the productivity of the color filter eminent.

The preferable vapor pressure of the liquid medium at 25° C. is no more than 0.1 mmHg, and in particular, no more than 0.05 mmHg. Having the vapor pressure of the liquid medium within the range described above effectively prevents clogging in the droplet discharge head which discharges the color filter ink, thereby enhancing the productivity of the color filter.

The preferable mass content of the liquid medium within the color filter ink is between 70 and 98 wt % inclusive, and particularly, between 80 and 95 wt %. Having the mass content of the liquid medium within the range described above provides an outstanding durability of the color filters being manufactured, while providing an excellent discharging performance of a droplet discharge device for color filters. Moreover, it ensures sufficient color density in the color filter being manufactured.

### Dispersant

A dispersant may be included in the color filter ink. This provides an outstanding dispersion stability of pigments even when, for instance, the color filter ink includes pigments with low dispersibility, thereby providing outstanding preservation stability in the color filter ink.

Examples of dispersant include cationic, anionic, nonionic, amphoteric, silicone, and fluorinated surfactants. Examples of surfactants include: polyoxyethylene alkyl ethers such as polyoxyethylene lauryl ether, polyoxyethylene stearyl ether, and polyoxyethylene oleyl ether; polyoxyethylene alkyl phenyl ethers such as polyoxyethylene n-octyl phenyl ether and polyoxyethylene n-nonylphenyl ether; polyethylene glycol diesters such as polyethylene glycol dilaurate and polyethylene glycol distearate; sorbitan fatty acid esters; fatty acid modified polyesters; tertiary amine modified polyurethanes; and polyethyleneimines. Examples of surfactant products include trade names such as: KP (manufactured by Shin-Etsu Chemical Co., Ltd.), POLYFLOW (manufactured by Kyoeisha Chemical Co., Ltd), EFTOP (formally manufactured by Tohkem Products Corporation; currently JEMCO Inc.), MEGAFAC (manufactured by Dainippon Ink & Chemicals, Inc.), Florade (manufactured by Sumitomo 3M Ltd.), AsahiGuard and Surflon (manufactured by Asahi Glass Co., Ltd), Disperbyk (manufactured by BYK Japan K.K.), and Solsperse (available from Zeneca K.K.).

Examples of materials for dispersant include cyamelide compounds. Using such compounds as a dispersant provides the color filter ink with an excellent discharging stability as well as the dispersibility of pigments in the color filter ink.

Examples of materials for the dispersant include compounds containing partial structures represented by the following formulae (I), and (II). Using such compounds as the dispersant provides the color filter ink with an outstanding dispersibility of the colorants (pigments) in the color filter ink as well as an excellent discharging stability therein.

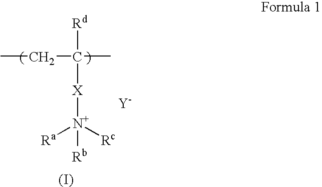

In the formula, R^{a}, R^{b}, and R^{c} are either independently selected from hydrogen, and one of substitutable ring and chain hydrocarbon groups, or, form a cyclic structure in which at least two of R^{a}, R^{b}, and R^{c} are attached to each other. R^{d} is selected from hydrogen and methyl group. X represents a divalent linking group, and Y⁻ represents a counter anion.

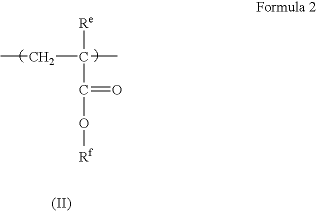

In the formula, R^{e} is selected from hydrogen and the methyl group. R^{f} is selected from either a ring or a chain alkyl group which may contain a substituent, the aryl group which may contain a substituent, and the aralkyl group which may contain a substituent.

The preferable mass content of the dispersant within the color filter ink is between 0.5 and 15 wt % inclusive, and particularly, between 0.5 and 8 wt %.

### Resin Material

The color filter ink generally includes a resin material (binder resin). This improves the adhesiveness between a colored layer and a substrate of the color filter to be manufactured, as well as the durability of the color filters.

Any resin material such as various thermoplastic resins and various thermosetting resins may be used as the resin material included in the color filter ink. However, epoxy resins are preferable. Epoxy resins have a high transparency and hardness, and at the same time, a low thermal contraction, thereby considerably improving the adhesiveness between the coloring portions and the substrate. Among the epoxy resins selected for the resin materials included in the color filter ink, it is preferable to use, in particular, ones containing a structure of silyl acetate (SiOCOCH₃) as well as a structure of epoxy. This improves the adhesiveness between the colored layer and the substrate, while carrying out the droplet discharge with the inkjet method in a preferable manner, thereby considerably improving the durability of the color filters.

The preferable mass content of the resin material within the color filter ink is between 0.5 and 10 wt % inclusive, and particularly, between 1 and 5 wt %. Having the mass content of the resin material within these ranges provides an outstanding durability of the color filters being manufactured, while providing excellent discharging performance of droplet discharge heads for color filters. Moreover, it ensures sufficient color density in the color filter being manufactured. If the mass content of the resin material is too low, there is a decline in the discharging performance of the color filter ink, as well as in the hardness of the coloring portions being formed, resulting in a deterioration in the durability of the color filters being manufactured. On the contrary, if the mass content of the resin material is too high, it becomes more difficult to ensure sufficient color density in the color filter being manufactured.

### Other Components

The color filter ink may include, as necessary, various other components. Examples of constituents (other additives) include various crosslinking agents, various polymerization initiators, dispersing agents, fillers, high polymer compounds, coupling promoters, antioxidants, ultraviolet absorbers, flocculation inhibitors, inkjet discharge stabilization agents, and surfactants. Examples of the above dispersing agents include derivatives of blue pigments such as derivatives of copper phthalocyanine and derivatives of yellow pigments. Examples of the fillers include glass and alumina. Examples of the high polymer compounds include polyvinyl alcohol, polyethylene glycol monoalkyl ether, and poly(fluoroalkyl acrylate). Examples of the above coupling promoters include: vinyltrimethoxysilane, vinyltriethoxysilane, vinyltris(2-methoxy-ethoxy)silane, N-(2-aminoethyl)-3-aminopropylmethyldimethoxysilane, N-(2-aminoethyl)-3-aminopropyltrimethoxysilane, 3-aminopropyltriethoxysilane, 3-glycidoxypropyltrimethoxysilane, 3-glycidoxypropylmethyldimethoxysilane, 2-(3,4-epoxycyclohexyl)ethyltrimethoxysilane, 3-chloropropylmethyldimethoxysilane, 3-chloropropyltrimethoxysilane, 3-methacryloxypropyltrimethoxysilane, and 3-mercaptopropyltrimethoxysilane. Examples of the antioxidant include 2,2-thiobis(4-methyl-6-t-butylphenol and 2,6-di-t-butylphenol. Examples of the above ultraviolet absorbers include 2-(3-t-butyl-5-methyl-2-hydroxyphenyl)-5-chlorobenzotriazole and alkoxybenzophenone. An example of flocculation inhibitors is sodium polyacrylic acid. Examples of the above inkjet discharge stabilization agents include methanol, ethanol, 1-propanol, n-butanol, and glycerin. Examples of surfactant products include trade names such as: EFTOP EF301, EF303, EF352 (manufactured by former Tohkem Products Corporation; currently JEMCO Inc.); MEGAFAC F171, F172, F173, F178K (manufactured by Dainippon Ink & Chemicals, Inc.); Florade FC430 and FC431 (manufactured by Sumitomo 3M Ltd.); AsahiGuard AG710 and Surflon S-382, SC-101, SC-102, SC-103, SC-104, SC-105, and SC-106 (manufactured by Asahi Glass Co., Ltd); KP 341 (manufactured by Shin-Etsu Chemical Co., Ltd.); and POLYFLOW No. 75 and No. 95 (manufactured by Kyoeisha Chemical Co., Ltd).

The color filter ink may include a thermal acid generator and an acid crosslinking agent. Examples of constituents of the thermal acid generator which generates acids by heating include salts such as onium salts of sulfonium, benzothiazolium, ammonium, and phosphonium. Particularly, salts of sulfonium and benzothiazolium are preferable.

There are no specific limitations imposed on the viscosity of the color filter ink at a temperature of 25° C. If the viscosity is measured by using a vibration viscometer, however, the range of 5 to 15 mPa·s is preferable, and in particular, 5 to 10 mPa·s. If the viscosity of the color filter ink is within the above range, it is possible to significantly reduce the fluctuation of a droplet quantity of the color filter ink being discharged by discharging droplets with the inkjet method, while ensuring the prevention of clogging in the droplet discharge head. The measurement of the viscosity of the color filter ink is carried out using, for instance, a vibration viscometer, and particularly, in compliance with the JIS Z8809.

### Ink Set

The color filter ink described above is used for manufacturing color filters with the inkjet method. Since color filters are generally compliant with a full color display, color filters have a plurality of coloring portions (generally, three colors corresponding to the three primary colors of RGB). Variations of color filter ink sets are used, each corresponding to a different color, in order to form those coloring portions. In other words, in order to manufacture the color filters, an ink set of the color filter ink is used, the set being provided with a plurality of colors. According to the aspects of the invention, the color filter ink described above may be used for at least one kind of the coloring portions, and preferably, in the formation of the coloring portions of all the colors.

### Color Filter

The color filters manufactured using the color filter ink set described above will now be described.

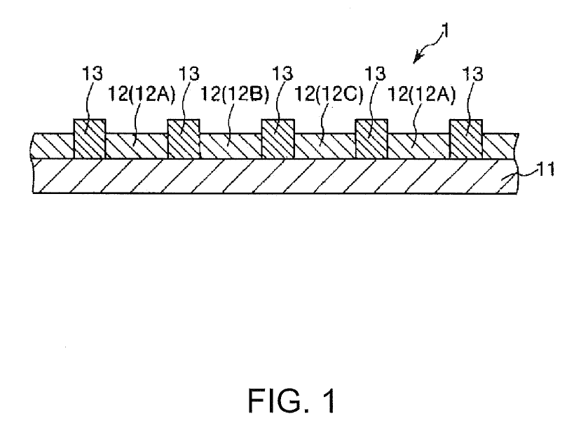

FIG. 1 is a schematic drawing illustrating a suitable embodiment of a color filter according to the first aspect of the invention.

As shown in FIG. 1, a color filter 1 includes a substrate 11, and coloring portions 12 formed using the color filter ink set described above. The coloring portions 12 are provided with a first coloring portion 12A, a second coloring portion 12B, and a third coloring portion 12C, each having a different color. Here, the first through third coloring portions 12A through 12C are provided in a plural number. A plurality of partition walls 13 is also provided between the adjacent coloring portions 12.

### Substrate

The substrate 11 is a plated member that has optical transparency, and has the ability to hold the coloring portions 12 and the partition walls 13.

It is preferable that the substrate 11 be composed of a substantially transparent material, since the light transmitting through the color filter 1 forms a clearer image.

It is preferable that the substrate 11 has outstanding heat resistance and mechanical strength. This ensures the prevention of problems such as deformation of the color filter 1 caused by the heat applied during the manufacturing thereof. Examples of constituting materials of the substrate 11 satisfying such conditions include: glass, silicon, polycarbonate, polyester, aromatic polyamide, polyamide-imide, polyimide, norbornene-based ring-opening polymer, and hydrogen additive thereof.

### Coloring Portions

The coloring portions 12 are formed using the color filter ink set described above.

The coloring portions 12 have less fluctuation of characteristics between pixels, since the coloring portions 12 are formed using the color filter ink set described above. This increases the reliability of the color filter 1, by suppressing the occurrence of irregularities in colors and densities of the color filter 1.

Each of the coloring portions 12 is provided inside cells 14 surrounded by the partition walls 13 described later.

The first coloring portions 12A, the second coloring portions 12B, and the third coloring portions 12C, respectively represent different colors. For instance, the first coloring portions 12A are set to red filter regions (R), the second coloring portions 12B are set to green filter regions (G), and the third coloring portions 12C are set to blue filter regions (B). A set including one of the first coloring portions 12A, one of the second coloring portions 12B, and one of the third coloring portions 12C constitutes one pixel. The prescribed number of coloring portions 12 are deposited in the horizontal direction as well as in the vertical direction of the color filter 1. For instance, the color filter 1 used as a color filter for high resolution, a color filter for full high resolution, and a color filter for super high resolution includes 1366*768 pixels, 1920*1080 pixels, and 7680*4320 pixels disposed thereon. The color filter 1 may also be provided with, for instance, spare pixels outside of the effective region.

### Partition Walls

The partition walls 13 are provided between the adjacent coloring portions 12. The partition walls ensure the prevention of color mixing between the adjacent coloring portions 12, thereby making the images to be displayed clear.

The partition walls 13 may be formed with a transparent material. However, a light-shielding material is preferable, so that the high contrast images are displayed. No specific limitation is imposed on the color of the partition walls (light-shielding portion) 13. However, black is preferable, which considerably improves the contrast of images being displayed.

No specific limitation is imposed on the height of the partition walls (light-shielding part) 13. However, the height may preferably be larger than the film thickness of the coloring portions 12. Consequently, it is possible to ensure the prevention of color mixing between the adjacent coloring portions 12. The preferable range for the thickness of the partition walls 13 is approximately 0.1 to 10 μm. Particularly, a range of 0.5 to 3.5 μm is preferable. Consequently, the color mixing between the adjacent coloring portions 12 is prevented, while improving the viewing angle property of an image display device and of an electronic apparatus provided with the color filter 1.

The partition walls 13 may be formed with any material. However, it is preferable that the partition walls 13 be formed mainly with resin materials. This enables the partition walls 13 to be formed into desired shapes with ease using a method described later. Moreover, if the partition walls 13 have a light-shielding functionality, the constituting material may include a light absorptive material such as carbon black.

### The Manufacturing Method of Color Filter

Examples of a method for manufacturing the color filter 1 will now be described.

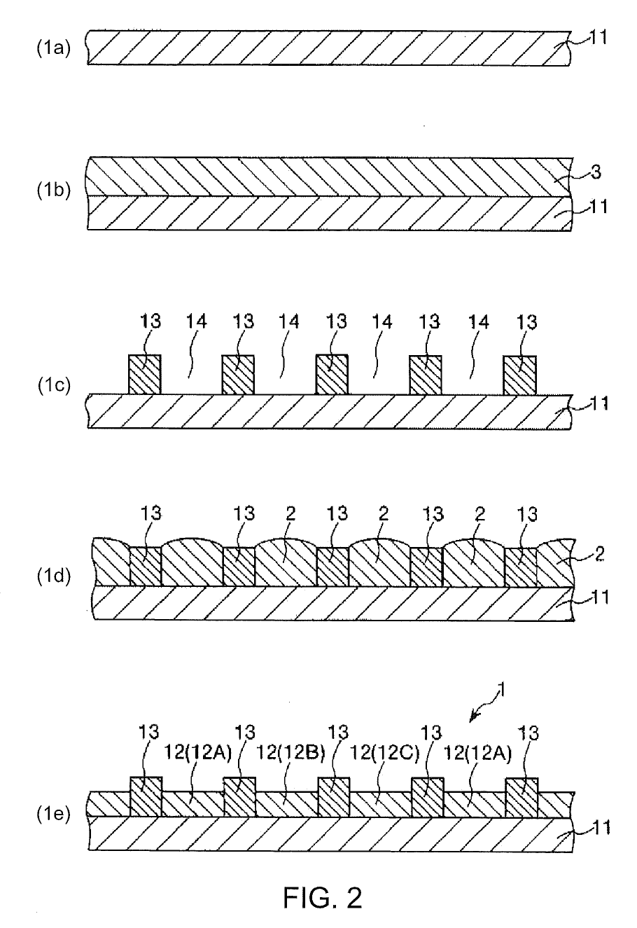

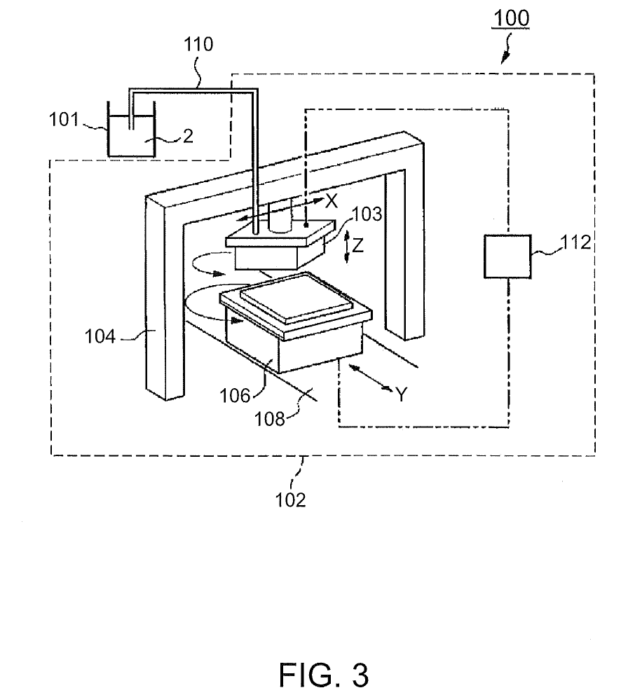

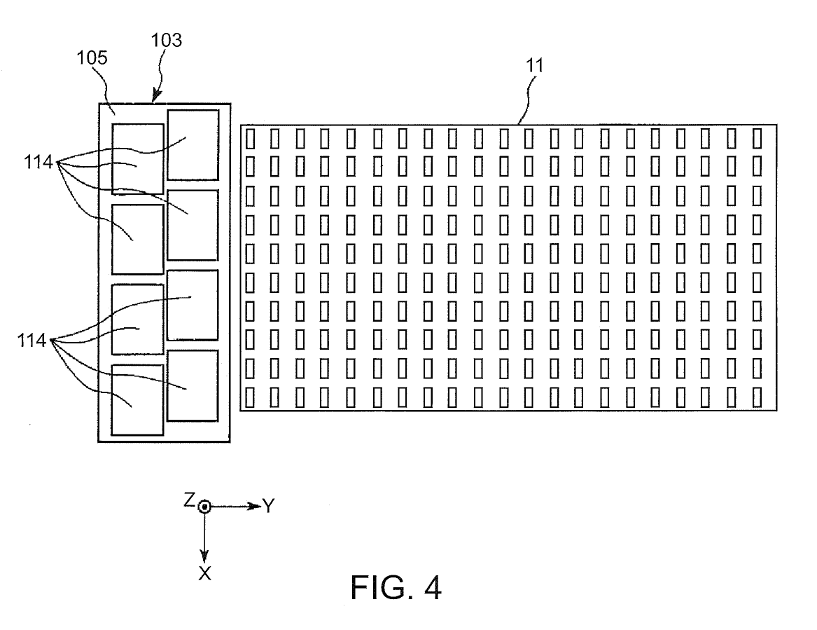

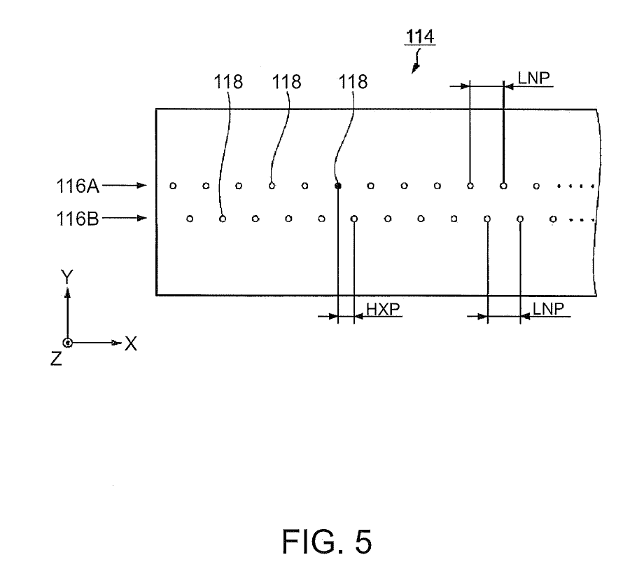

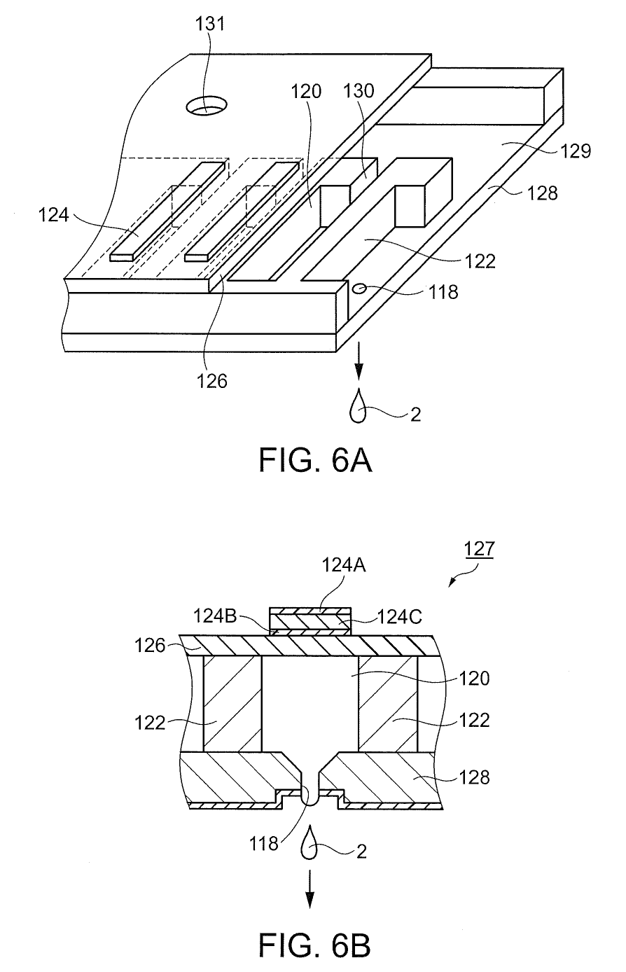

FIG. 2 is a sectional drawings illustrating a method for manufacturing the color filter; FIG. 3 is an perspective view illustrating a droplet discharge device used for manufacturing the color filter; FIG. 4 is a drawing of a droplet discharge unit of the droplet discharge device shown in FIG. 3 as viewed from a stage thereof; FIG. 5 is a drawing illustrating the bottom surface of a droplet discharge head of the droplet discharge device shown in FIG. 3; and FIGS. 6A and 6B are drawings illustrating the bottom surface of a droplet discharge head of the droplet discharge device shown in FIG. 3, where FIG. 6A is a sectional perspective view and FIG. 6B is a sectional view.

As shown in FIG. 2, this embodiment includes: a substrate preparation process (1a) for preparing the substrate 11; partition wall forming processes (1b and 1c) for forming the partition walls 13 on the substrate 11; an ink deposition process (1d) for depositing color filter ink 2 on regions surrounded by the partition walls 13; and a coloring portions forming process for removing the liquid medium from the color filter ink 2 so as to produce the coloring portions 12 in a solid state.

### Substrate Preparation Process

First, the substrate 11 is prepared (1a). The substrate 11 prepared in this process should preferably be after cleaning. Moreover, arbitrary pre-treatments may be carried out on the substrate 11, the pre-treatments including: chemical treatment using an agent such as a silane coupling agent, plasma treatment, ion plating, sputtering, vacuum deposition, and a gas-phase reaction method.

### Forming Partition Walls

Thereafter, a radiation-sensitive composition for forming the partition wall on the substrate 11 is applied to approximately the entire surface of the substrate 11, so as to form a coating 3 (1b). A pre bake processing may be carried out as necessary, after applying the radiation-sensitive composition on the substrate 11. The pre bake processing can be carried out in the conditions of, for instance, a heating temperature of 50 to 150° C., and a heating time of 30 to 600 seconds.

Thereafter, a radioactive ray is irradiated thereon through a photomask, so as to carry out post exposure processing (PEB), and thereafter a developing processing is carried out using an alkaline developer, thereby forming the partition walls 13 (1c). The PEB may be carried out in the conditions of, for instance, a heating temperature of 50 to 150° C., a heating time of 30 to 600 seconds, and an irradiation intensity of 1 to 500 mJ/cm². The developing processing can be carried out by methods such as pouring, dipping, and oscillation immersion, and the developing processing time may be set to, for instance, 10 to 300 seconds. Post bake processing may also be performed as necessary after the developing processing. The post bake processing can be carried out in the conditions of, for instance, a heating temperature of 150 to 280° C., and a heating time of 3 to 120 minutes.

### Ink Deposition Process

Subsequently, the color filter ink 2 is applied within the cells 14 surrounded by the partition walls 13, with the inkjet method (1d).

This process is carried out using the ink set including a plurality of types of color filter ink 2, each type corresponding to a different color used in the coloring portions 12. The partition walls 13 are provided, thereby ensuring the prevention of mixing of two or more ink sets of color filter ink 2.

Discharging of the color filter ink 2 is carried out using a droplet discharge device illustrated in FIGS. 3 through 6.

As shown in FIG. 3, a droplet discharge device 100 used in this process includes a tank 101 that holds the color filter ink 2, a tube (fluid transfer tube) 110 for transferring the color filter ink 2 inside the tank 101, and a discharge scanning unit 102 to which the color filter ink 2 is supplied from the tank 101 through the tube 110. The discharge scan unit 102 includes: a droplet discharge unit 103 that has a plurality of droplet discharge heads (inkjet heads) 114 mounted on a carriage 105; a first position control device (moving unit) 104 that controls the position of the droplet discharge unit 103; a stage 106 that holds the substrate 11 on which the partition walls 13 are formed in the previous process (hereafter also referred to as “the substrate 11”); a second position control device (moving unit) 108 that controls the position of the stage 106; and a control unit 112. The tank 101 and the plurality of droplet discharge heads 114 in the droplet discharge unit 103 are coupled with the tube (fluid transfer tube) 110, and the color filter ink 2 is supplied from the tank 101 to the droplet discharge heads 114, using compressed air. The tube (fluid transfer tube) 110 and the droplet discharge unit 103 (droplet discharge heads 114) are joined with a non-illustrated joint material. Vibration energy caused by the fluid transfer tends to work on the joint between the tube (fluid transfer tube) 110 and the droplet discharge unit 103 (droplet discharge heads 114), and moreover, from this joint, there is a higher chance of air mixing into the color filter ink 2 being transferred. Therefore, butyl rubber is generally used as the constituting material of the joint material, since the butyl rubber has rich flexibility, low gas permeability, and excels in vibration insulation, water-resistance, acid tolerance, alkali tolerance, and weatherability. Examples of butyl rubber used as a material composing the joint material include products with trade names such as Butyl 065, 268, 269, and 365 (Exxon Mobile Corporation); Laxess butyl 101-3, 301, and 402 (Lanxess Corporation); and JSR butyl (JSR Corporation).

The color filter ink supplied to the droplet discharge head is discharged toward the inside of the cells on the substrate provided with the partition walls. Here, the droplet discharge devices (industrial) used for manufacturing the color filters are entirely different from the ones applied for printers (consumer use). For instance, the industrial droplet discharge device is required to be able to discharge a large amount of droplets for a long period of time for mass production. Moreover, the industrial droplet discharge devices used for manufacturing the color filters use ink with higher viscosity and a larger specific gravity compared to ink used in consumer use printers. Therefore, the load on the industrial droplet discharge devices is considerably larger compared to consumer use printers. The deterioration of the constituting members (components) of such droplet discharge devices takes place fast due to these harsh conditions, causing problems such as instability of the discharge quantity of droplets. Such deterioration of the joint material causes bubbles to be mixed into the color filter ink supplied to the droplet discharge heads, eminently generating the fluctuation of droplet discharge quantity as well as the defective discharge (chattering). Such a problem causes unevenness in the coloring density of the coloring portions which are essential to have identical coloring density. This results in irregularities such as color irregularity and density irregularity in different parts of the color filters. Moreover, the reliability of color filters is reduced due to the uneven characteristics (specifically, color characteristics such as contrast ratio and color reproduction area) in multiple color filters. On the contrary, according to the aspects of the invention, using the color filter ink that satisfies the aforementioned conditions effectively prevents the occurrence of these problems, even if the droplet discharge is carried out for a long period of time.

The first position control device 104 moves the droplet discharge unit 103 along the x-axis and the z-axis orthogonal to the x-axis, corresponding to signals from the control unit 112. Moreover, the first position control device 104 has an ability to rotate the droplet discharge unit 103 around the direction parallel to the z-axis. In this embodiment, the z-axis is the direction parallel to the vertical direction (in other words, the direction of a gravitational acceleration). The second position control device 108 moves the stage 106 along the y-axis orthogonal to both the y-axis and the z-axis, corresponding to signals from the control unit 112. Moreover, the second position control device 108 has an ability to rotate the stage 106 around the direction parallel to the z-axis.

The stage 106 has flat surfaces parallel to each other in the directions of both the x-axis and the y-axis, and is configured to fix or to hold the substrate 11 to its planar surface, the substrate 11 containing the cells 14 to which the color filter ink 2 is to be applied.

As described above, the first position control device 104 moves the droplet discharge unit 103 in the x-axis direction. At the same time, the second position control device 108 moves the stage 106 in the y-axis direction. In other words, the first position control device 104 and the second position control device 108 change the position of the droplet discharge heads 114 relative to the stage 106 (the droplet discharge unit 103 moves relative to the substrate 11 held on the stage 106).

The control unit 112 is configured to receive discharge data from an external information processing device, the data indicating the relative position as to where the color filter ink 2 is to be discharged.

As shown in FIG. 4, the droplet discharge unit 103 includes the plurality of droplet discharge heads 114, each having approximately the same structure, and the carriage 105 that holds those droplet discharge heads 114. In this embodiment, the number of droplet discharge heads 114 held by the droplet discharge unit 103 is eight. Each of the droplet discharge heads 114 has a bottom surface provided with a plurality of nozzles 118 described later. The shape of the bottom surface of each of the droplet discharge heads 114 is a polygon, having two longer sides and two shorter sides, each two sides facing one another. The bottom surface of the droplet discharge heads 114 held by the droplet discharge unit 103 faces the stage 106, and the longer sides and the shorter sides of the droplet discharge heads 114 are respectively parallel to the x-axis and the y-axis.

As shown in FIG. 5, the droplet discharge heads 114 have the plurality of nozzles 118 aligned in the x-axis direction. This plurality of nozzles 118 is arranged so that a nozzle pitch HXP of the droplet discharge heads 114 in the x-axis direction has a prescribed distance between the nozzles 118. The specific value of the HXP is not specifically limited, but can be set to, for instance, a range of 50 to 90 μm. Here, the nozzle pitch HXP in the direction of x-axis in the droplet discharge heads 114 is equivalent to the distance between a plurality of nozzle images obtained by projecting all the nozzles 118 in the droplet discharge heads 114, in the x-axis direction along the y-axis direction.

According to this embodiment, the plurality of nozzles 118 in the droplet discharge heads 114 includes a nozzle row 116A and a nozzle row 116B, both extended in the x-axis direction. The nozzle row 116A and the nozzle row 116B are arranged in parallel to each other, having intervals therebetween, respectively containing 90 nozzles (nozzles 118) arranged to form a line in the x-axis direction with a constant interval LNP. The specific value of the LNP is not specifically limited, but can be set to a range of 100 to 180 μm.

The position of the nozzle row 116B is shifted in the positive direction of the x-axis (rightward in FIG. 5) by half the length of the constant interval LNP, in relation to the position of the nozzle row 116A. Therefore, the nozzle pitch HXP in the x-axis direction of the droplet discharge heads 114 is equal to half of the constant interval LNP of the nozzle row 116A (or nozzle row 116B).

Therefore, the nozzle line density of the droplet discharge heads 114 in the x-axis direction is twice as large as the nozzle line density of the nozzle row 116A (or the nozzle row 116B). For the purposes of this specification, the “nozzle line density in the x-axis direction” is equivalent to the number of nozzle images in a unit length, the nozzle images being obtained by projecting the plurality of nozzles on the x-axis direction along the y-axis direction. The number of nozzle rows contained in the droplet discharge heads 114 is not limited to two, and the droplet discharge heads 114 may include M nozzle rows, where M is a positive integer equal to or greater than 1. In this case, the plurality of nozzles 118 in each of the M nozzle rows is arranged at a pitch that is M times as long as the nozzle pitch HXP. Moreover, if M is a positive integer equal to or greater than 2, the rest of the (M−1) nozzle rows are shifted in the x-axis direction, without overlaps of nozzles, by a length “i” times as large as the nozzle pitch HXP. Here, “i” is a positive integer ranging from 1 to (M−1).

There are 180 nozzles (nozzles 118) included in each of the droplet discharge heads 114, including the nozzle row 116A and the nozzle row 116B, each containing 90 nozzles. The five nozzles at both ends of the nozzle row 116A are configured as “cessation nozzles”. Similarly, the five nozzles at both ends of the nozzle row 116B are configured as “cessation nozzles”. No color filter ink 2 is discharged from these 20 cessation nozzles. Therefore, out of the 180 nozzles (nozzles 118) in the droplet discharge heads 114, 160 nozzles (nozzles 118) function as the nozzles that discharge the color filter ink 2.

As shown in FIG. 4, in the droplet discharge unit 103, the plurality of droplet discharge heads 114 are arranged in two rows along the x-axis direction. The droplet discharge heads 114 of one row and the droplet discharge heads 114 of the other row are arranged to partly overlap with each other when viewed from the y-axis direction, in consideration of the cessation nozzles. Consequently, the droplet discharge unit 103 is configured so that the nozzles 118 discharging the color filter ink 2 are arranged continuously in the x-axis direction at the nozzle pitch HXP, within a length of the substrate 11 in the x-axis direction.

In this embodiment, the droplet discharge heads 114 are arranged in the droplet discharge unit 103 so that they cover the entire length of the substrate 11 in the x-axis direction. However, the droplet discharge unit according to the aspects of the invention may be set to cover a part of the length of the substrate 11 in the x-axis direction.

As shown in FIGS. 6A and 6B, each of the liquid discharge heads 114 is an inkjet head. Specifically, each of the droplet discharge heads 114 includes a vibration plate 126 and a nozzle plate 128. There is a liquid retention pit 129 positioned between the vibration plate 126 and the nozzle plate 128, and the color filter ink 2 is constantly filled therein, supplied from the tank 101 through a hole 131.

A plurality of partition walls 122 is also positioned between the vibration plate 126 and the nozzle plate 128. A part surrounded by the vibration plate 126, the nozzle plate 128, and a pair of partition walls 122 is called a cavity 120 (the cavity 120 is provided in a plural number). Since one cavity 120 is installed per every nozzle 118, the number of cavities 120 and nozzles 118 is the same. The color filter ink 2 is supplied to the cavity 120 from the liquid retention pit 129 via a supply mouth 130 positioned between a pair of partition walls 122.

An oscillator 124 is placed corresponding to each of the cavities 120 on the vibration plate 126. The oscillator 124 includes a piezo element 124C and a pair of electrodes 124A and 124B having the piezo element 124C therebetween. By applying a drive voltage between the pair of electrodes 124A and 124B, the color filter ink 2 is discharged from the corresponding nozzles 118. Here, the shapes of the nozzles 118 are adjusted so that the color filter ink 2 is discharged from the nozzles 118 in the z-axis direction.

Generally, in the droplet discharge heads 114 (particularly, in the vicinity of the nozzle plate 128), the joint material used to compose the ink supply unit and the head drive unit is an elastic material. If the ink supply unit and the head drive unit are not joined properly, problems may occur, such as ink leakage, the improper applying of pressure to the color filter ink 2 within the cavity 120, and the mixing of gas into the cavity 120 from outside. In order to avoid such problems, fluorosilicone rubber is generally used as the joint material. Examples of such fluorosilicone rubber include products with trade names such as: Silastic LS (Dow Corning Corporation); FE251-U, 261-U, 271-U, 273-U, and 281-U (Shin-Etsu Chemical Co., Ltd.); and Fluorsilicone 614002 (ERIKS).

The control unit 112 (refer to FIG. 3) may be configured to provide signals to the plurality of oscillators 124 independently. In other words, the volume of the color filter ink 2 discharged from the plurality of nozzles 118 may be controlled separately for each of the plurality of nozzles 118 in accordance with the signals from the control unit 112. Moreover, the control unit 112 can set which of the plurality of nozzles 118 carry out the discharge operation and which do not during a coating scanning.

In this document, a portion containing one of the plurality of nozzles 118, the cavity 120 corresponding to that nozzle 118, and the oscillator 124 corresponding to that cavity 120 may be referred to as “discharge unit 127”. According to this notation, the single droplet discharge head 114 includes the same number of discharge units 127 as that of the plurality of nozzles 118.

The color filter ink 2 is applied to the inside of the cells 14 using the droplet discharge device 100 described above, the color filter ink 2 corresponding to the coloring portions 12 with different colors, contained in the color filter 1. Using the above device allows a more efficient and selective deposition of the color filter ink 2 into the cells 14. According to the illustrated structures, components such as the tube 110 and the tank 101 for containing the color filter ink 2 included in the droplet discharge device 100 are only for one color. However, those components may be provided for the plurality of colors corresponding to the coloring portions 12 with different colors included in the color filter 1. Moreover, in the manufacturing of the color filter 1, a plurality of droplet discharge devices 100 may be used, each corresponding to a color of the color filter ink 2.

According to the aspects of the invention, the droplet discharge heads 114 may use an electrostatic actuator as a drive element, instead of the piezo element. Moreover, the droplet discharge heads 114 may also use an electrothermal converter as the drive element, and discharge the color filter ink, utilizing the thermal expansion of the material caused by the electrothermal converter.

### The Forming Process of Coloring Portion

Thereafter, the liquid medium is removed from the color filter ink 2 in the cells 14, thereby forming the coloring portions 12 in a solid state (1e). As a result, the color filter 1 is obtained. In this process, the resin material may react with a crosslinking constituent as necessary. Removing the liquid medium may be carried out, for instance, by heating. At this time, the substrate 11 on which the color filter ink 2 is deposited may be left in an environment of reduced pressure. This efficiently removes the liquid medium, while preventing an adverse effect on components such as the substrate 11. Moreover, irradiation of a radioactive ray may be carried out in this process. This allows an efficient progression of reaction between the resin material and the crosslinking constituent.

### Image Display Device

Suitable embodiments of a liquid crystal display device which is an image display device (electro-optical device) having the color filter 1 will now be described.

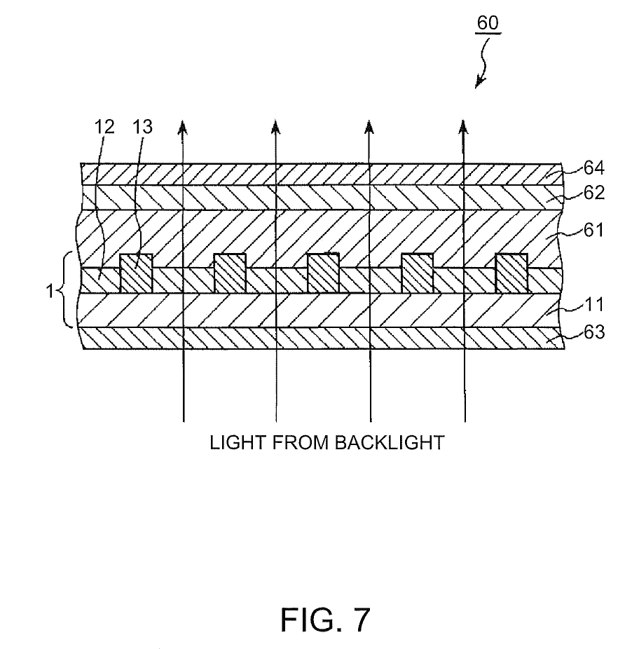

FIG. 7 is a sectional drawing illustrating a suitable embodiment of the liquid crystal display device. As shown in the drawing, a liquid crystal display device 60 includes: the color filter 1; a substrate (counter substrate) 62 provided to face the coloring portions 12 of the color filter 1; a liquid crystal layer 61 composed of liquid crystal sealed into a gap between the color filter 1 and the substrate 62; a polarizing plate 63 provided at the lower part of the substrate 11 under the color filter 1 in FIG. 7, and a polarizing plate 64 provided at the upper part of the substrate 11 in FIG. 7. The substrate 62 has an optical transparency against visible light, for instance, a glass substrate.

The liquid crystal display device 60 is arranged in a matrix, and includes a plurality of pixel electrode having an optical transparency against visible light, a plurality of switching element corresponding to pixel electrodes (for instance, thin film transistors, or, TFT); and a common electrode (none of the above is illustrated).

In this liquid crystal display device 60, the light emitted from an un-illustrated backlight enters from the side of the color filter 1 (lower side in FIG. 7). The incident light in the coloring portions 12 (12A, 12B, and 12C) of the color filter 1 is emitted out as colored light from the opposite surface, the color of light corresponding to the coloring portions 12 (12A, 12B, and 12C).

As described, the coloring portions 12 have less fluctuation of characteristics between pixels, since they are formed using the color filter ink 2 according to the first aspect of the invention. As a result, the liquid crystal display device 60 displays, in a stable manner, an image having a reduced irregularity of colors and densities.

### Electronic Apparatus

An image display device (electro-optical device) 1000 that has the above-described color filter 1, for example a liquid crystal display device, may be used as a display of various electronic apparatuses.

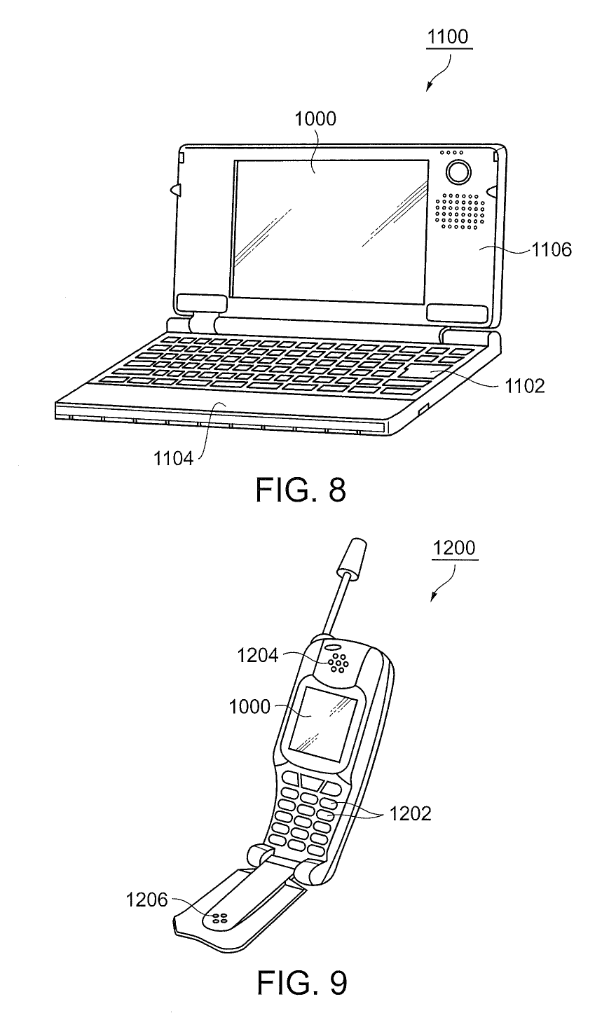

FIG. 8 is a perspective view illustrating a structure of a mobile (or notebook) personal computer in which an electronic apparatus according to aspects of the invention is applied.

In this drawing, a personal computer 1100 is composed including a body 1104 provided with a keyboard 1102, and a display unit 1106 which is supported so that it can pivot around a hinge relative to the body 1104.

The display unit 1106 of this personal computer 1100 is provided with the image display device 1000.

FIG. 9 is a perspective view illustrating a mobile (including personal handyphone system) phone to which an electronic apparatus according to aspects of the invention is applied.

The mobile phone 1200 in this drawing is provided with the image display device 1000 in a display section, along with a plurality of operation buttons 1202, an earpiece 1204, and a mouthpiece 1206.

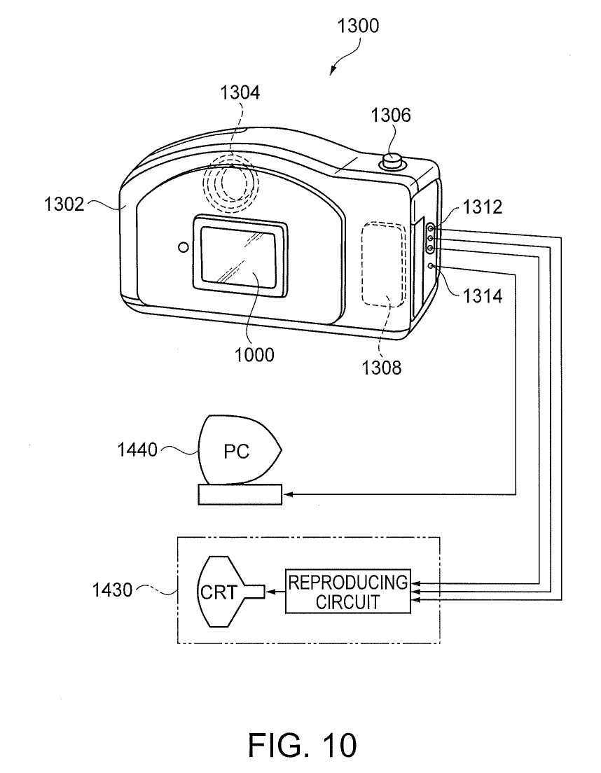

FIG. 10 is a perspective view illustrating the structure of a digital still camera to which an electronic apparatus according to aspects of the invention is applied. This drawing also briefly illustrates the connection with external apparatuses.

While in a traditional analog camera, a silver halide photographic film is exposed to a optical image of a subject, a digital still camera 1300 performs a photoelectronic conversion of light image of the subject, using image sensors such as a charge coupled device (CCD), so as to generate imaging signals (image signals).

The image display device 1000 is provided to a display section at the back of a case (body) 1302 of the digital still camera 1300. The display section serves as a finder for displaying the subject as an electronic image based on the imaging signals from the CCD.

A circuit board 1308 is installed inside the case. A memory unit which allows storing (memorizing) the imaging signals is installed on this circuit board 1308.

A light receiving unit 1304 is installed on the front or back side of the case 1302 (in the drawing, the back side), the light receiving unit 1304 including components such as an optical lens (optical imaging system) and CCD.

If a user confirms the subject displayed in the display section and presses a shutter button 1306, the imaging signal of the CCD at that moment is transferred to and stored in the memory of the circuit board 1308.

This digital still camera 1300 has a video signal output terminal 1312 and a data communication input-output terminal 1314, provided on the side of the case 1302. As shown in the drawing, a television monitor 1430 is coupled with the video signal output terminal 1312, and a personal computer 1440 is coupled with the input-output terminal 1314 used for data communication as necessary. A predetermined operation outputs the imaging signals stored in the memory of the circuit substrate 1308 to the television monitor 1430 or to the personal computer 1440.

The electronic apparatus according to the aspects of the invention may be applied to the personal computer (mobile PC), the mobile phone, and the digital still camera described above. Other examples include: televisions such as liquid crystal televisions, video cameras, video tape recorders with models such as a viewfinder or a direct viewing monitor, laptop personal computers, car navigation devices, pagers, electronic notebooks (including the ones with communication capability), electronic dictionaries, electric calculators, electronic gaming apparatuses, word processors, workstations, video phones, security television monitors, electronic binoculars, POS terminals, apparatuses incorporating touch panels such as cash dispensers in financial institutions and ticketing machines, medical apparatuses such as electronic thermometers, hemadynamometer, glycemia, electrocardiographic display devices, ultrasound devices, endoscopes display devices, fish detectors, various measuring instruments, gauges such as the ones for vehicles, airplanes and ships, flight simulators, other various monitors, and projector display devices such as projectors. Particularly, display units of televisions are growing larger, which is a prominent trend. These electronic apparatuses having large-size display units with, for instance, a diagonal length of 80 cm or more, tend to have occurrences of problems such as color irregularity and density irregularity, if the color filters applied thereto are manufactured using common inks for color filters. Applying the aspects of the invention ensures prevention of such problems. In other words, the advantages of the invention are exhibited notably when applying the aspects of the invention to electronic apparatuses that have such large-size display units.

The present invention shall not be limited to the exemplary embodiments described above.

For instance, in the aforementioned embodiments, the description is mentioned for the case in which the coloring portion forming process is carried out once. In other words, the color filter ink sets, each corresponding to the coloring portions of each color, are disposed inside the cells, and thereafter, the liquid agents are removed from the color filter ink sets of all the colors within the cells. However, the ink disposing process and the coloring portion forming process may be carried out for one color, may be repeated for all the color.

Moreover, in the color filters according to the aspects of the invention, a protection film may be included for coating the coloring portions, the protection film being provided on the surface opposite to the one facing the substrate of the coloring portions. Consequently, deterioration of or damage to the coloring portions are prevented effectively.

Further, components constituting the color filter, the image display device, and the electronic apparatus may be altered with arbitrary ones that exhibit similar functionality. Alternatively, another structure may also be added thereto.

### EXAMPLES

### 1. Preparation of Ink for Color Filter

### First Example

A “resin a” was first synthesized as a resin material with the following steps.

320 parts by weight (pbw) of n-hexane, 86 pbw of methacrylic acid, and 111 pbw of triethylamine were poured into a four-neck flask, and thereafter, a thermometer, a reflux condenser, an agitator, and a nitrogen gas introduction feed were installed thereto. While cooling this four-neck flask with ice water, 120 pbw of trimethylchlorosilane was instilled therein. At this time, the temperature of this reaction system is kept at no more than 25° C. The reaction was continued at 25° C. for one hour. Triethylamine hydrochloride was then filtered, and n-hexane was removed from the obtained filtrate under a reduced pressure. Thereafter, the resultant was refined with a reduced-pressure distillation, thereby obtaining an ethylene unsaturated monomer having a structure of silyl acetate.

Subsequently, a four-neck flask was set, including: a thermometer, a reflux condenser, an agitator, and a nitrogen gas introduction feed installed thereon; and a solvent of 100 pbw of bis(2-butoxyethyl)ether feed therein. After increasing the temperature of bis(2-butoxyethyl)ether in this four-neck flask to 60° C. while agitating it, a mixture of 27 pbw of ethylene unsaturated monomer, 30 pbw of glycidyl methacrylate, 38 pbw of styrene, and 6 pbw of 2,2′-azobis-(2,4-dimethylvaleronitrile) was instilled therein for an hour. The flask was allowed to stand for one hour at 60° C. after the instillation, and 0.08 pbw of 2,2′-azobis-(2,4-dimethylvaleronitrile) was then added, and the content of the flask was reacted for another 6 hours at 60° C., thereafter unreacted monomers were removed by a decompression treatment, thereby obtaining a solution of an epoxy resin “resin a” containing structures of silyl acetate and epoxy.

Aside from the above, bis(2-butoxyethyl)ether (fluid medium) was prepared, and Disperbyk-161 (a cyamelide compound, manufactured by BYK Japan K.K.), as well as the colorants of C.I. pigment red 254 and C.I. pigment yellow 150 were added. This is introduced into a beads mill (using 10.65 mm zirconia beads) so as to grind the pigments, thereby obtaining the pigment dispersant. Thereafter, by mixing a solution of the “resin a” and the pigment dispersant, the red ink for a color filter (R ink) was prepared. The average grain sizes of C.I. pigment red 254 and of C.I. pigment yellow 150 were both 160 nm.

Green ink for a color filter (G ink) and blue ink for a color filter (B ink) were respectively prepared with a method similar to that of the red ink for a color filter, except for modifying the variation of colorants and quantities of components being used. The ink set composed of three sets of ink for the three colors of R, G, and B was thereby obtained. The average grain sizes of C.I. pigment red 36 and of C.I. pigment yellow 150 in the G ink, as well as of C.I. pigment red 15:6 in the B ink were all 160 nm.

### Second to Thirteenth Examples

The color filter ink sets were prepared with a method similar to the first example, except that the variation of liquid media and the quantities of components being used were set according to the tables. In the case of modifying the composition of the liquid medium, the “resin a” was synthesized using a solvent in which the composition thereof was modified accordingly, and a solution of the “resin a” thereby synthesized was used for the preparation of the color filter ink.

### First to Eighth Comparative Examples

The color filter ink sets were prepared with a method similar to the first example, except that the variation and the quantities of components being used were set according to the tables. In the case of modifying the composition of the liquid medium, the “resin a” was synthesized using a solvent in which the composition thereof was modified accordingly, and a solution of the “resin a” thereby synthesized was used for the preparation of the color filter ink.

The compositions and viscosities of the color filter ink sets, as well as the characteristics of the liquid media, are arranged in Tables 1 to 3 for the first through thirteenth examples as well as for the first through eighth comparative examples. In Tables 1 to 3, C.I. pigment red 254 is represented as “PR254”, C.I. pigment green 36 is represented as “PG36”, C.I. pigment blue 15:6 is represented as “PB15:6”, C.I. pigment yellow 150 is represented as “PY150”, the “resin a” is represented as “a”, Disperbyk-161 (dispersant) is represented as “b”, bis(2-butoxyethyl)ether is represented as “A”, triethylene glycol dimethyl ether is represented as “B”, triethylene glycol diacetate is represented as “C”, tetraethylene glycol dimethyl ether is represented as “D”, triethylene glycol butyl methyl ether is represented as “E”, diethylene glycol monoethyl ether acetate is represented as “F”, 1,6-diacetoxyhexane is represented as “G”, 1,3-butylene glycol diacetate is represented as “H”, dipropylene glycol methyl ether acetate is represented as “I”, propylene carbonate is represented as “J”, and diethylene glycol monobutyl ether acetate is represented as “K”. Moreover, each of the “viscosity” columns in the tables indicates the viscosity of the color filter ink at a temperature of 25° C., measured by a vibration viscometer, in compliance with JIS Z8809. Each of the “boiling point” columns indicates the boiling point of the liquid media under normal pressure (1 atmosphere), and each of the “vapor pressure” columns indicates the vapor pressure of the liquid medium at a temperature of 25° C. Each of the “swelling ratio of butyl rubber” columns indicates the swelling ratio of a disk-shaped testing piece with a diameter of 6 mm and a thickness of 4 mm composed of a solid butyl rubber (JSR butyl manufactured by JSR Corporation), the testing piece being left inside the liquid medium in a sealed state for 10 days in an environment of atmospheric pressure at 40° C. Each of the “swelling ratio of fluorosilicone rubber” columns indicates the swelling ratio of a disk-shaped testing piece with a diameter of 6 mm and a thickness of 4 mm composed of a solid fluorosilicone (Fluorsilicone 614002 manufactured by ERIKS), the testing piece being allowed to stand for 10 days inside the liquid medium in a sealed state under atmospheric pressure at 40° C.

TABLE 1

| | | Inks for Color Filters | | | | | | | | | | | Characteristics of Liquid Medium | | | |
|---|---|---|---|---|---|---|---|---|---|---|---|---|---|---|---|---|
| | | Composition | | | | | | | | | | | | | Swell- | Swell- |
| | | | | | | Resin | | | | | | | | | ing | ing |
| | | Colorant | | | | Material | | Dispersant | | Liquid Medium | | | Boil- | | Ratio of | Ratio of |
| | | | Content | | Content | | Content | | Content | | Content | Viscos- | ing | Vapor | Butyl | Silicone |
| | | | [Part by | | [Part by | | [Part by | | [Part by | | [Part by | ity | Point | Pressure | Rubber | Rubber |
| | | | Weight] | | Weight] | | Weight] | | Weight] | | Weight] | [mP · s] | [° C.] | [mmHg] | [%] | [%] |
| First | R | PR254 | 5.3 | PY150 | 2.0 | a | 1.9 | b | 4.8 | A | 86.0 | 7.2 | 256.0 | 0.01 | 17.71 | 5.43 |
| Example | ink | | | | | | | | | | | | | | | |
| | G | PG36 | 7.2 | PY150 | 2.9 | a | 2.0 | b | 4.8 | A | 83.1 | 7.0 | 256.0 | 0.01 | 17.71 | 5.43 |
| | ink | | | | | | | | | | | | | | | |
| | B | PB15:6 | 4.9 | — | — | a | 1.9 | b | 4.5 | A | 88.7 | 6.8 | 256.0 | 0.01 | 17.71 | 5.43 |
| | ink | | | | | | | | | | | | | | | |
| Second | R | PR254 | 5.0 | PY150 | 1.9 | a | 2.1 | b | 4.8 | B | 86.2 | 6.7 | 216.0 | 0.0403 | 6.5 | 5.08 |
| Example | ink | | | | | | | | | | | | | | | |
| | G | PG36 | 7.1 | PY150 | 2.8 | a | 2.3 | b | 4.9 | B | 82.9 | 6.9 | 216.0 | 0.0403 | 6.5 | 5.08 |
| | ink | | | | | | | | | | | | | | | |
| | B | PB15:6 | 4.4 | — | — | a | 2.1 | b | 4.9 | B | 88.6 | 6.5 | 216.0 | 0.0403 | 6.5 | 5.08 |
| | ink | | | | | | | | | | | | | | | |
| Third | R | PR254 | 5.2 | PY150 | 2.0 | a | 2.2 | b | 5.0 | C | 85.6 | 7.5 | 286.0 | 0.09 | 1.38 | 3.97 |
| Example | ink | | | | | | | | | | | | | | | |
| | G | PG36 | 7.1 | PY150 | 2.9 | a | 2.2 | b | 5.1 | C | 82.7 | 7.7 | 286.0 | 0.09 | 1.38 | 3.97 |
| | ink | | | | | | | | | | | | | | | |
| | B | PB15:6 | 4.5 | — | — | a | 2.3 | b | 4.8 | C | 88.4 | 7.4 | 286.0 | 0.09 | 1.38 | 3.97 |
| | ink | | | | | | | | | | | | | | | |
| Fourth | R | PR254 | 5.1 | PY150 | 1.9 | a | 2.0 | b | 4.8 | D | 86.2 | 8.3 | 275.3 | 0.0067 | 4.77 | 2.59 |
| Example | ink | | | | | | | | | | | | | | | |
| | G | PG36 | 7.4 | PY150 | 3.0 | a | 2.1 | b | 5.1 | D | 82.4 | 8.3 | 275.3 | 0.0067 | 4.77 | 2.59 |
| | ink | | | | | | | | | | | | | | | |
| | B | PB15:6 | 4.8 | — | — | a | 1.9 | b | 4.9 | D | 88.4 | 8.2 | 275.3 | 0.0067 | 4.77 | 2.59 |
| | ink | | | | | | | | | | | | | | | |
| Fifth | R | PR254 | 5.0 | PY150 | 2.0 | a | 2.1 | b | 5.0 | E | 85.9 | 7.8 | 261 | 0.02 | 8.62 | 5.13 |
| Example | ink | | | | | | | | | | | | | | | |
| | G | PG36 | 6.9 | PY150 | 2.8 | a | 1.9 | b | 4.8 | E | 83.6 | 7.9 | 261 | 0.02 | 8.62 | 5.13 |
| | ink | | | | | | | | | | | | | | | |
| | B | PB15:6 | 5.0 | — | — | a | 1.9 | b | 5.0 | E | 88.1 | 7.7 | 261 | 0.02 | 8.62 | 5.13 |
| | ink | | | | | | | | | | | | | | | |
| Sixth | R | PR254 | 5.1 | PY150 | 2.0 | a | 2.1 | b | 5.0 | C/D | 51.5/34.3 | 7.9 | 222.3 | 0.14 | 2.74 | 3.42 |
| Example | ink | | | | | | | | | | | | | | | |
| | G | PG36 | 7.0 | PY150 | 2.8 | a | 1.9 | b | 4.8 | C/D | 54.3/29.2 | 7.9 | 217.9 | 0.16 | 2.57 | 3.49 |
| | ink | | | | | | | | | | | | | | | |
| | B | PB15:6 | 4.9 | — | — | a | 1.9 | b | 5.0 | C/D | 48.5/39.7 | 7.8 | 226.7 | 0.14 | 2.91 | 3.35 |
| | ink | | | | | | | | | | | | | | | |
| Seventh | R | PR254 | 5.0 | PY150 | 2.1 | a | 2.0 | b | 4.9 | B/D | 17.2/68.8 | 8.0 | 263.4 | 0.01 | 5.12 | 3.09 |
| Example | ink | | | | | | | | | | | | | | | |
| | G | PG36 | 6.9 | PY150 | 2.9 | a | 1.8 | b | 4.9 | B/D | 25.1/58.4 | 8.1 | 257.5 | 0.01 | 5.29 | 3.34 |
| | ink | | | | | | | | | | | | | | | |
| | B | PB15:6 | 4.9 | — | — | a | 2.0 | b | 5.0 | B/D | 17.6/70.5 | 7.9 | 263.4 | 0.01 | 5.12 | 3.09 |
| | ink | | | | | | | | | | | | | | | |
| Eighth | R | PR254 | 5.2 | PY150 | 1.9 | a | 2.1 | b | 4.8 | A/C | 43.0/43.0 | 7.2 | 221.5 | 0.05 | 9.55 | 4.7 |
| Example | ink | | | | | | | | | | | | | | | |
| | G | PG36 | 7.0 | PY150 | 2.8 | a | 1.9 | b | 4.8 | A/C | 37.6/45.9 | 7.4 | 218.1 | 0.05 | 8.73 | 4.6 |
| | ink | | | | | | | | | | | | | | | |
| | B | PB15:6 | 4.8 | — | — | a | 2.1 | b | 4.9 | A/C | 44.1/44.1 | 7.1 | 221.5 | 0.05 | 9.55 | 4.7 |
| | ink | | | | | | | | | | | | | | | |

TABLE 2

| | | Inks for Color Filters | | | | | | | | | | | Characteristics of Liquid Medium | | | |
|---|---|---|---|---|---|---|---|---|---|---|---|---|---|---|---|---|
| | | Composition | | | | | | | | | | | | | Swell- | Swell- |
| | | | | | | Resin | | | | | | | | | ing | ing |
| | | Colorant | | | | Material | | Dispersant | | Liquid Medium | | | Boil- | | Ratio of | Ratio of |
| | | | Content | | Content | | Content | | Content | | Content | Viscos- | ing | Vapor | Butyl | Silicone |
| | | | [Part by | | [Part by | | [Part by | | [Part by | | [Part by | ity | Point | Pressure | Rubber | Rubber |
| | | | Weight] | | Weight] | | Weight] | | Weight] | | Weight] | [mP · s] | [° C.] | [mmHg] | [%] | [%] |
| Ninth | R | PR254 | 5.2 | PY150 | 2.0 | a | 2.1 | b | 4.7 | A/D | 43.0/43.0 | 7.7 | 266 | 0.01 | 11.24 | 4.01 |
| Example | ink | | | | | | | | | | | | | | | |
| | G | PG36 | 7.2 | PY150 | 2.8 | a | 1.9 | b | 4.8 | A/D | 37.5/45.8 | 7.6 | 267 | 0.01 | 10.59 | 3.87 |
| | ink | | | | | | | | | | | | | | | |
| | B | PB15:6 | 4.8 | — | — | a | 2.1 | b | 4.8 | A/D | 44.1/44.1 | 7.5 | 266 | 0.01 | 11.24 | 4.01 |
| | ink | | | | | | | | | | | | | | | |
| Tenth | R | PR254 | 5.3 | PY150 | 1.9 | a | 2.1 | b | 4.9 | A/B | 68.6/17.2 | 6.9 | 248 | 0.02 | 15.47 | 5.36 |
| Example | ink | | | | | | | | | | | | | | | |
| | G | PG36 | 7.2 | PY150 | 3.0 | a | 2.1 | b | 4.9 | A/B | 66.2/16.6 | 7.1 | 248 | 0.02 | 15.47 | 5.36 |
| | ink | | | | | | | | | | | | | | | |
| | B | PB15:6 | 4.7 | — | — | a | 2.1 | b | 5.0 | A/B | 70.6/17.6 | 6.8 | 248 | 0.02 | 15.47 | 5.36 |
| | ink | | | | | | | | | | | | | | | |
| Eleventh | R | PR254 | 5.1 | PY150 | 2.0 | a | 2.1 | b | 4.8 | C/E | 30.1/55.9 | 7.6 | 235 | 0.09 | 6.09 | 4.72 |
| Example | ink | | | | | | | | | | | | | | | |
| | G | PG36 | 7.1 | PY150 | 2.9 | a | 2.3 | b | 4.8 | C/E | 29.0/53.9 | 7.8 | 235 | 0.09 | 6.09 | 4.72 |
| | ink | | | | | | | | | | | | | | | |
| | B | PB15:6 | 4.8 | — | — | a | 2.3 | b | 5.0 | C/E | 3.08/57.1 | 7.6 | 235 | 0.09 | 6.09 | 4.72 |
| | ink | | | | | | | | | | | | | | | |
| Twelfth | R | PR254 | 5.2 | PY150 | 2.1 | a | 2.1 | b | 4.7 | D/E | 21.5/64.4 | 8.2 | 265 | 0.02 | 7.66 | 4.50 |
| Example | ink | | | | | | | | | | | | | | | |
| | G | PG36 | 7.1 | PY150 | 3.0 | a | 2.1 | b | 4.8 | D/E | 20.8/62.2 | 8.1 | 265 | 0.02 | 7.66 | 4.50 |
| | ink | | | | | | | | | | | | | | | |
| | B | PB15:6 | 4.9 | — | — | a | 2.3 | b | 4.9 | D/E | 22.0/65.9 | 7.8 | 265 | 0.02 | 7.66 | 4.50 |
| | ink | | | | | | | | | | | | | | | |
| Thirteenth | R | PR254 | 5.0 | PY150 | 2.1 | a | 2.2 | b | 4.9 | A/E | 60.1/25.7 | 7.1 | 257 | 0.01 | 14.98 | 5.34 |
| Example | ink | | | | | | | | | | | | | | | |
| | G | PG36 | 7.0 | PY150 | 2.9 | a | 2.2 | b | 4.8 | A/E | 58.2/24.9 | 7.2 | 257 | 0.01 | 14.98 | 5.34 |
| | ink | | | | | | | | | | | | | | | |
| | B | PB15:6 | 4.8 | — | — | a | 2.1 | b | 4.8 | A/E | 61.8/26.5 | 7.0 | 257 | 0.01 | 14.98 | 5.34 |
| | ink | | | | | | | | | | | | | | | |

TABLE 3

| | | Inks for Color Filters | | | | | | | | | | | Characteristics of Liquid Medium | | | |
|---|---|---|---|---|---|---|---|---|---|---|---|---|---|---|---|---|
| | | Composition | | | | | | | | | | | | | Swell- | Swell- |
| | | | | | | Resin | | | | | | | | | ing | ing |
| | | Colorant | | | | Material | | Dispersant | | Liquid Medium | | | Boil- | | Ratio of | Ratio of |
| | | | Content | | Content | | Content | | Content | | Content | Viscos- | ing | Vapor | Butyl | Silicone |
| | | | [Part by | | [Part by | | [Part by | | [Part by | | [Part by | ity | Point | Pressure | Rubber | Rubber |
| | | | Weight] | | Weight] | | Weight] | | Weight] | | Weight] | [mP · s] | [° C.] | [mmHg] | [%] | [%] |
| First | R | PR254 | 5.1 | PY150 | 1.9 | a | 2.0 | b | 4.8 | F | 86.2 | 7.3 | 217.0 | 0.0989 | 71.03 | 11.46 |
| Compara- | ink | | | | | | | | | | | | | | | |
| tive | G | PG36 | 7.3 | PY150 | 2.8 | a | 2.2 | b | 4.9 | F | 82.8 | 7.5 | 217.0 | 0.0989 | 71.03 | 11.46 |
| Example | ink | | | | | | | | | | | | | | | |
| | B | PB15:6 | 4.8 | — | — | a | 1.9 | b | 4.9 | F | 88.4 | 7.3 | 217.0 | 0.0989 | 71.03 | 11.46 |
| | ink | | | | | | | | | | | | | | | |
| Second | R | PR254 | 5.2 | PY150 | 2.0 | a | 2.2 | b | 4.6 | G | 86.0 | 8.7 | 250 | 0.02 | 84.42 | 29.12 |
| Compara- | ink | | | | | | | | | | | | | | | |
| tive | G | PG36 | 7.5 | PY150 | 2.9 | a | 2.1 | b | 5.0 | G | 82.5 | 8.7 | 250 | 0.02 | 84.42 | 29.12 |
| Example | ink | | | | | | | | | | | | | | | |
| | B | PB15:6 | 4.8 | — | — | a | 1.8 | b | 4.5 | G | 88.9 | 8.6 | 250 | 0.02 | 84.42 | 29.12 |
| | ink | | | | | | | | | | | | | | | |
| Third | R | PR254 | 5.3 | PY150 | 2.1 | a | 2.1 | b | 4.8 | H | 85.7 | 7.7 | 232.0 | 0.04 | 65.63 | 15.63 |
| Compara- | ink | | | | | | | | | | | | | | | |
| tive | G | PG36 | 7.4 | PY150 | 2.9 | a | 2.2 | b | 5.2 | H | 82.3 | 7.9 | 232.0 | 0.04 | 65.63 | 15.63 |
| Example | ink | | | | | | | | | | | | | | | |
| | B | PB15:6 | 4.8 | — | — | a | 1.8 | b | 4.5 | HI | 88.9 | 7.6 | 232.0 | 0.04 | 65.63 | 15.63 |
| | ink | | | | | | | | | | | | | | | |
| Fourth | R | PR254 | 5.1 | PY150 | 2.0 | a | 2.0 | b | 4.7 | I | 86.2 | 6.3 | 213.0 | 0.02 | 61.27 | 17.15 |
| Compara- | ink | | | | | | | | | | | | | | | |
| tive | G | PG36 | 7.5 | PY150 | 2.8 | a | 2.1 | b | 4.9 | I | 82.7 | 6.4 | 213.0 | 0.02 | 61.27 | 17.15 |
| Example | ink | | | | | | | | | | | | | | | |
| | B | PB15:6 | 4.8 | — | — | a | 1.8 | b | 4.6 | I | 88.8 | 6.1 | 213.0 | 0.02 | 91.27 | 17.15 |
| | ink | | | | | | | | | | | | | | | |
| Fifth | R | PR254 | 5.0 | PY150 | 2.2 | a | 2.1 | b | 4.7 | J | 86.0 | 7.4 | 243 | 0.03 | 60.79 | 7.67 |
| Compara- | ink | | | | | | | | | | | | | | | |
| tive | G | PG36 | 7.2 | PY150 | 2.8 | a | 2.1 | b | 4.9 | J | 83.0 | 7.4 | 243 | 0.03 | 60.79 | 7.67 |
| Example | ink | | | | | | | | | | | | | | | |
| | B | PB15:6 | 4.8 | — | — | a | 1.9 | b | 5.1 | J | 88.2 | 7.2 | 243 | 0.03 | 60.79 | 7.67 |
| | ink | | | | | | | | | | | | | | | |
| Sixth | R | PR254 | 5.3 | PY150 | 1.9 | a | 2.9 | b | 5.4 | K | 84.5 | 8.1 | 246.8 | 0.04 | 58.07 | 10.04 |
| Compara- | ink | | | | | | | | | | | | | | | |
| tive | G | PG36 | 7.2 | PY150 | 2.5 | a | 2.8 | b | 5.0 | K | 82.5 | 8.3 | 246.8 | 0.04 | 58.07 | 10.04 |
| Example | ink | | | | | | | | | | | | | | | |
| | B | PB15:6 | 4.4 | — | — | a | 2.1 | b | 4.9 | K | 88.6 | 7.9 | 246.8 | 0.04 | 58.07 | 10.04 |
| | ink | | | | | | | | | | | | | | | |
| Seventh | R | PR254 | 5.0 | PY150 | 2.1 | a | 1.9 | b | 5.0 | F/G | 60.2/25.8 | 7.9 | 229.9 | 0.08 | 74.45 | 16.76 |
| Compara- | ink | | | | | | | | | | | | | | | |
| tive | G | PG36 | 6.9 | PY150 | 2.8 | a | 2.2 | b | 4.8 | F/G | 58.3/25.0 | 7.9 | 229.9 | 0.08 | 74.45 | 16.76 |
| Example | ink | | | | | | | | | | | | | | | |
| | B | PB15:6 | 4.8 | — | — | a | 2.2 | b | 4.8 | F/G | 61.7/26.5 | 7.7 | 229.9 | 0.08 | 74.45 | 16.76 |
| | ink | | | | | | | | | | | | | | | |
| Eighth | R | PR254 | 5.1 | PY150 | 2.1 | a | 2.0 | b | 4.7 | G/I | 51.7/34.4 | 8.1 | 241.2 | 0.02 | 73.96 | 24.33 |
| Compara- | ink | | | | | | | | | | | | | | | |
| tive | G | PG36 | 6.9 | PY150 | 2.8 | a | 2.2 | b | 5.1 | G/I | 49.8/33.2 | 8.3 | 241.2 | 0.02 | 73.96 | 24.33 |
| Example | ink | | | | | | | | | | | | | | | |
| | B | PB15:6 | 4.8 | — | — | a | 2.3 | b | 4.9 | G/I | 52.8/35.2 | 7.8 | 241.2 | 0.02 | 73.96 | 24.33 |
| | ink | | | | | | | | | | | | | | | |

### 2. Manufacturing Color Filter

The color filters were produced using the color filter ink sets prepared in the examples and in the comparative examples described above. The process thereof will now be described.

A substrate composed of soda glass with size G5 (1100*1300 mm) was readied and cleaned, the substrate including a silica (SiO₂) film formed on both sides thereof so as to prevent the eluting of sodium ions.

Thereafter, radiation-sensitive composition containing carbon black for forming the partition walls was applied to the entire surface of the cleaned substrate, so as to form a coating.

Subsequently, a pre bake processing was carried out in conditions of a heating temperature of 110° C., and a heating time of 120 seconds.

Thereafter, a radioactive ray was irradiated on the substrate through a photomask, so as to carry out a post exposure processing (PEB), and thereafter a developing processing was carried out using an alkaline developer, followed by a post bake processing, thereby forming the partition walls. The PEB was carried out in conditions of a heating temperature of 110° C., a heating time of 120 seconds, and an irradiation intensity of 150 mJ/cm². Moreover, the developing processing was carried out with, for instance, an oscillation immersion. The developing processing time was set to 60 seconds, and the post bake processing was carried out in conditions of a heating temperature of 150° C., and a heating time of 5 minutes. The thickness of the partition walls was 2.1 μm.

Subsequently, using the droplet discharge device shown in FIGS. 3 to 6, the color filter ink was ejected within the cells surrounded by the partition walls. At this time, the three-color color filter ink set was used, so that the color filter ink representing each color would not be mixed with each other. Moreover, in this droplet discharge device, the tube (fluid transfer tube) and the droplet discharge unit (droplet discharge head) were joined by the joint material formed with butyl rubber (JSR butyl manufactured by JSR Corporation), and the ink supply unit and the head drive unit of the droplet discharge head were joined by the joint material formed with fluorosilicone rubber (Fluorsilicone 614002 manufactured by ERIKS).

Thereafter, heat processing was carried out on the substrate on a hot plate at 100° C. for 10 minutes, and thereafter for 1 hour in an oven at 200° C., thereby forming the coloring portions for three colors. As a result, the color filter shown in FIG. 1 was obtained.

One thousand color filters were produced respectively for each of the examples and the comparative examples, using the color filter ink sets corresponding to those examples.

### 3. Evaluation

The following evaluations were carried out using the color filters obtained in the above processes.

### 3.1 Irregularities of Colors and Densities, and Light Leakage

The liquid crystal display device shown in FIG. 7 was manufactured using the thousandth color filter among the color filters manufactured using the color filter ink set according to each of the aforementioned examples and comparative examples. All the examples shared the identical manufacturing conditions.

Using these liquid display devices, visual observations were made in a dark room respectively for red, green, blue, and white in a monochrome display, so as to evaluate the occurrence of irregularities of colors and densities. The evaluations were carried out in accordance with the following five standards.

A: No irregularities of colors and densities, nor any light leakage were observed.
B: Almost no irregularities of colors and densities, nor any light leakage were observed.
C: Irregularities of colors and densities and light leakage were observed slightly.
D: Irregularities of colors and densities and light leakage were observed clearly.
E: Irregularities of colors and densities and light leakage were observed dominantly.

### 3.2 Difference of Characteristics between Individual Units

Among the color filters manufactured using the color filter ink set according to each of the aforementioned examples and comparative examples, sequentially manufactured color filters 900 to 999 were selected from each example. Those color filters were lit in a dark room for red, green, blue, and white respectively in a monochrome display for colorimetry with a spectrophotometer (MCPD3000 manufactured by Otsuka Electronics Co., Ltd). The maximum color difference (the color difference ΔE in a lab display system) of color filters 990 to 999 manufactured in each example was obtained from the result of the colorimetry, and was evaluated in accordance with the following five standards.

A: The color difference ΔE is less than 2.
B: The color difference ΔE is equal to or greater than 2 and less than 3.
C: The color difference ΔE is equal to or greater than 3 and less than 4.
D: The color difference ΔE is equal to or greater than 4 and less than 5.
A: The color difference ΔE is equal to or greater than 5.

In the above evaluation, the same condition was applied to the observation and the measurement of all the color filters.

The results thereof are listed in Table 4.

TABLE 4

| | Color Irregularity, | | | | | | | |
|---|---|---|---|---|---|---|---|---|
| | Density Irregularity, | | | | Difference in Characteristics | | | |
| | and Light Leakage | | | | between Individual Units | | | |
| | Red | Green | Blue | White | Red | Green | Blue | White |
| | Display | Display | Display | Display | Display | Display | Display | Display |
| First | A | A | A | A | A | A | A | A |
| Embodiment | | | | | | | | |
| Second | B | B | A | B | B | B | A | B |
| Embodiment | | | | | | | | |
| Third | A | A | A | A | A | A | A | A |
| Embodiment | | | | | | | | |
| Fourth | A | B | A | A | A | B | A | A |
| Embodiment | | | | | | | | |
| Fifth | A | A | A | A | A | A | A | A |
| Embodiment | | | | | | | | |
| Sixth | A | B | A | A | A | B | A | A |
| Embodiment | | | | | | | | |
| Seventh | A | B | A | B | A | B | A | B |
| Embodiment | | | | | | | | |
| Eighth | A | A | A | A | A | A | A | A |
| Embodiment | | | | | | | | |
| Ninth | A | A | A | A | A | A | A | A |
| Embodiment | | | | | | | | |
| Tenth | A | B | A | A | A | B | A | A |
| Embodiment | | | | | | | | |
| Eleventh | A | A | A | A | A | A | A | A |
| Embodiment | | | | | | | | |
| Twelfth | A | B | A | A | A | B | A | A |
| Embodiment | | | | | | | | |
| Thirteenth | A | A | A | A | A | A | A | A |
| Embodiment | | | | | | | | |
| First | D | D | C | D | D | D | C | D |
| Comparative | | | | | | | | |
| Example | | | | | | | | |
| Second | C | D | C | C | C | D | C | C |
| Comparative | | | | | | | | |
| Example | | | | | | | | |
| Third | B | C | A | C | B | C | A | C |
| Comparative | | | | | | | | |
| Example | | | | | | | | |
| Fourth | B | C | B | C | B | C | B | C |
| Comparative | | | | | | | | |
| Example | | | | | | | | |
| Fifth | C | D | C | C | C | D | C | C |
| Comparative | | | | | | | | |
| Example | | | | | | | | |
| Sixth | B | C | A | C | B | C | A | C |
| Comparative | | | | | | | | |
| Example | | | | | | | | |
| Seventh | C | D | C | D | C | D | C | E |
| Comparative | | | | | | | | |
| Example | | | | | | | | |
| Eighth | D | E | D | E | D | E | D | E |
| Comparative | | | | | | | | |
| Example | | | | | | | | |

As indicated in Table 4, color mixing, color irregularity, density irregularity, and light leakage were reduced in the color filters according to the aspects of the invention, having a smaller fluctuation of characteristics between individual color filters. In contrast, results were not satisfactory in the comparative examples.

Similar results were obtained in the evaluation of the portions of liquid crystal display devices in the liquid crystal televisions that are commercially available. Here, the evaluation was carried out in a manner similar to that of the aforementioned examples, by exchanging the above portions with the ones manufactured according to the aforementioned examples.

What is claimed is:

1. A color filter ink for manufacturing a color filter with an ink-jet method, the ink comprising:
a colorant; and
a liquid medium into which the colorant is dissolved and/or dispersed,
the liquid medium including at least one ether oxygen atom within a molecule, in addition to radicals provided at both ends of a molecular chain, the radicals both being selected from at least one an alkoxyl group and an acetyl group,
wherein if a hardened butyl rubber is sealed inside the liquid medium for 10 days under atmospheric pressure at 40° C., a swelling ratio of the hardened butyl rubber is not higher than 20%.

2. The color filter ink according to claim 1, wherein the liquid medium includes at least two ether oxygen atoms within a molecule, in addition to radicals provided at both ends of a molecular chain, the radicals both being selected from at least one of the alkoxyl group and the acetyl group.

3. The color filter ink according to claim 1, wherein the liquid medium has a straight-chain molecular structure which does not include a side chain.

4. A droplet discharge device for manufacturing a color filter with an inkjet method, the device comprising:
an inkjet head for discharging droplets;
a fluid transfer tube joined to the inkjet head by a joint material formed with butyl rubber; and
color filter ink adapted to be sent through the fluid transfer tube to the inkjet head, the color filter ink including:
a colorant;
a liquid medium into which the colorant is dissolved and/or dispersed, the liquid medium including at least one ether oxygen atom within a molecule, in addition to radicals provided at both ends of a molecular chain, the radicals both being selected from at least one of an alkoxyl group and an acetyl group, and
a swelling characteristic that causes hardened butyl rubber sealed inside the liquid medium for 10 days under atmospheric pressure at 40° C. to have a swelling ratio of not higher than 20%.

5. A color filter ink for manufacturing a color filter with an ink-jet method, the ink comprising:
a colorant; and
a liquid medium into which the colorant is dissolved and/or dispersed,
the liquid medium including at least one ether oxygen atom within a molecule, in addition to radicals provided at both ends of a molecular chain, the radicals both being selected from at least one of an alkoxyl group and an acetyl group,
wherein if a hardened fluorosilicone rubber is sealed inside the liquid medium for 10 days under atmospheric pressure at 40° C., a swelling ratio of the hardened fluorosilicone rubber is not higher than 7%.

6. The color filter ink according to claim 1, wherein a boiling point of the liquid medium under atmospheric pressure is between 180 and 300° C. inclusive.

7. The color filter ink according to claim 1, wherein a vapor pressure of the liquid medium at 25° C. is 0.1 mmHg or less.

8. A color filter manufactured using the color filter according to claim 1.

9. An image display device including the color filter according to claim 8.

10. The image display device according to claim 9, wherein the image display device is a liquid crystal panel.

11. An electronic apparatus including the image display device according to claim 9.
